(19) United States
(12) Patent Application Publication
(10) Pub. No.: US 2009/0135349 A1
(43) Pub. Date: May 28, 2009

(54) METHOD FOR MANUFACTURING COLOR FILTER INK, COLOR FILTER INK, COLOR FILTER, IMAGE DISPLAY DEVICE, AND ELECTRONIC DEVICE

(75) Inventors: Masaya SHIBATANI, Matsumoto (JP); Mitsuhiro ISOBE, Kofu (JP); Hiroshi KIGUCHI, Suwa (JP); Akihiro SHINTANI, Shiojiri-shi (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/264,573

(22) Filed: Nov. 4, 2008

(30) Foreign Application Priority Data
Nov. 27, 2007 (JP) 2007-305361

(51) Int. Cl. G02F 1/1335; C09D 11/10; C08L 83/06; C08K 5/10; C08K 5/103; C08K 5/06

(52) U.S. Cl. 349/106; 524/588; 524/310; 524/317; 524/377

(57) ABSTRACT

A method for manufacturing a color filter ink is adapted to be used to manufacture a color filter by an inkjet method. The method includes dispersing a dispersing agent in a solvent to obtain a dispersing-agent-dispersed liquid by agitating a mixture of the dispersing agent, a thermoplastic resin and the solvent, performing a fine dispersion treatment to obtain a pigment dispersed material by adding a pigment to the dispersing-agent-dispersed liquid and by adding inorganic beads to the dispersing-agent-dispersed liquid in multiple stages, and mixing the pigment dispersed material with a curable resin.

### CROSS-REFERENCE TO RELATED APPLICATIONS

This application claims priority to Japanese Patent Application No. 2007-305361 filed on Nov. 27, 2007. The entire disclosure of Japanese Patent Application No. 2007-305361 is hereby incorporated herein by reference.

### BACKGROUND

1. Technical Field

The present invention relates to a method for manufacturing a color filter ink, a color filter ink, a color filter, an image display device, and an electronic device.

2. Related Art

Color filters are generally used in liquid crystal display devices (LCD) and the like that display color.

Color filters have conventionally been manufactured using a so-called photolithography method in which a coating film composed of a material (color layer formation composition) that includes a colorant, a photosensitive resin, a functional monomer, a polymerization initiator, and other components is formed on a substrate, and then photosensitive processing for radiating light via a photomask, development processing, and the like are performed. In such a method, the color filters are usually manufactured by repeating a process in which a coating film corresponding to each color is formed on substantially the entire surface of the substrate, only a portion of the coating film is cured, and most of the film other than the cured portion is removed, so that there is no color overlap. Therefore, only a portion of the coating film formed in color filter manufacturing remains as a color layer in the finished color filter, and most of the coating film is removed in the manufacturing process. Therefore, not only does the manufacturing cost of the color filter increase, but the process is also undesirable from the perspective of conserving resources.

Methods have recently been proposed for forming the color layer of a color filter through the use of an inkjet head (droplet discharge head) (see Japanese Laid-open Patent Publication No. 2002-372613, for example). In such a method, because the discharge position and the like of droplets of the material (color layer formation composition) used to form the color layer are easily controlled, and waste of the color layer formation composition can be reduced, the environmental impact can be reduced, and manufacturing cost can also be minimized. However, in a method for manufacturing a color filter using an inkjet head, when droplets are discharged for long periods of time, and droplets are discharged continuously, the trajectory of the discharged droplets changes (so-called flight deflection occurs), it becomes impossible to land the droplets in the desired region, the droplet discharge quantity becomes unstable, and other problems occur. When such problems occur, the different inks used to form colored portions of different colors on the substrate or the like onto which the droplets are to be discharged become mixed together (i.e., the colors mix) and the color saturation varies among colored portions that were supposed to have the same color saturation. As a result, uneven color and uneven saturation occur between regions of the same color filter, variation of characteristics (particularly contrast ratio, color reproduction range, and other color characteristics) occurs among numerous color filters, and the reliability of the color filters is reduced. Since the droplet discharge device (industrial) used for color filter manufacturing is entirely different from what is used for a printer (consumer-level), and the droplet discharge device is used for mass production and droplet discharge onto large-scale workpieces (substrates), for example, there is a need to discharge large quantities of droplets for long periods of time. Because the droplet discharge device is used under such harsh conditions, the droplet discharge quantity easily fluctuates in comparison to a consumer droplet discharge device, but when the discharge quantity varies in this manner, fluctuation of the characteristics between numerous manufactured color filters, or fluctuation in the color saturation in different areas of a color filter occurs, and the reliability of the color filter as a product is markedly reduced.

Since pigments generally have superior color fastness to light and heat resistance in comparison to dyes, pigments are widely used as colorants in color filter inks. However, when a pigment is used as a colorant, the aforementioned problems accompanying discharge of the color filter ink from an inkjet head become more prominent. Furthermore, when a conventional color filter ink using a pigment as a colorant is used, it is clearly difficult to manufacture a color filter that can produce a display an image having sufficiently good contrast. Moreover, when multiple color filters are manufactured using a conventional color filter ink with an inkjet method, the contrast characteristics of the manufactured color filters decline markedly.

### SUMMARY

An object of the present invention is to provide an inkjet-type color filter ink that has excellent discharge stability and excellent long-term dispersion stability (dispersion stability) of a pigment and enables a color filter to be manufactured which can produce a display image having excellent lightness and contrast, in which unevenness of color and saturation among regions is suppressed, and which has excellent durability and uniformity of characteristics between individual units. It is also an object of the present invention to provide a manufacturing method for manufacturing such a color filter ink in a favorable fashion. Still another object is to provide a color filter that can produce a display image having excellent contrast, in which unevenness of color and saturation among regions is suppressed, and that has excellent durability and uniformity of characteristics between individual units. Another object is to provide an image display device and electronic device equipped with the color filter.

The aforementioned objects are achieved by the present invention, which is described below.

A method for manufacturing a color filter ink according to the first aspect is adapted to be used to manufacture a color filter by an inkjet method. The method includes dispersing a dispersing agent in a solvent to obtain a dispersing-agent-dispersed liquid by agitating a mixture of the dispersing agent, a thermoplastic resin and the solvent, performing a fine dispersion treatment to obtain a pigment dispersed material by adding a pigment to the dispersing-agent-dispersed liquid and by adding inorganic beads to the dispersing-agent-dispersed liquid in multiple stages, and mixing the pigment dispersed material with a curable resin.

In this way, it is possible to provide a method for manufacturing a color filter ink with which it is possible to manufacture an inkjet-type color filter ink that has excellent discharge stability and excellent long-term dispersion stability (dispersion stability) of a pigment and can be used favorably to manufacture a color filter having excellent durability, suppressed unevenness of color and saturation among regions, excellent uniformity of properties between units, and the ability to produce a display image having excellent contrast.

In the method as described above, an epoxy resin having a silyl acetate structure (SiOCOCH3) and an epoxy structure is preferably used as the curable resin.

With such a structure, the long-term dispersion stability of the pigment particles in the color filter ink can be made to be particularly excellent. In particular, the long-term dispersion stability of the pigment particles is excellent when the color filter ink is kept at a high temperature. Additionally, the discharge stability of the color filter ink is particularly excellent and a color filter manufactured using the color filter ink can be used to display an image having particularly excellent contrast.

In the method as described above, the fine dispersing treatment preferably involves executing a first dispersion using first inorganic beads having a prescribed average particle diameter and, afterwards, executing a second dispersion using second inorganic beads having a smaller average particle diameter than the first inorganic beads.

With such a method, the long-term dispersion stability of the pigment particles in the color filter ink can be made to be particularly excellent.

In the method as described above, it is preferable for the first inorganic beads to have an average particle diameter of 0.5 to 2.0 mm and the second inorganic beads to have an average particle diameter of 0.03 to 0.30 mm.

With such a method, the long-term dispersion stability of the pigment particles in the color filter ink can be made to be particularly excellent. Furthermore, the color filter ink can be manufactured with good efficiency and with particularly excellent productivity.

In the method as described above, the fine dispersion treatment preferably has only two dispersion stages including the first dispersion and the second dispersion.

With such a method, the long-term dispersion stability of the pigment particles in the color filter ink can be made to be particularly excellent. Furthermore, the color filter ink can be manufactured with particularly excellent productivity.

In the method as described above, it is preferable for the solvent to include one or more compound selected from the group consisting of 1,3-butylene glycol diacetate, diethylene glycol dibutyl ether, and diethylene glycol monobutyl ether acetate.

With such a method, the long-term dispersion stability of the pigment particles in the color filter ink can be made to be particularly excellent. Furthermore, the color filter ink can be manufactured with good efficiency and with particularly excellent productivity.

In the method as described above, the pigment is preferably selected from among C.I. pigment red 177, C.I. pigment red 177 and a derivative thereof, C.I. pigment red 254, and C.I. pigment red 254 and a derivative thereof.

In this way, a color filter ink having particularly excellent long-term dispersion of the pigment particles can be obtained.

In the method as described above, the pigment is preferably C.I. pigment green 58 or C.I. pigment green 58 and a derivative of a pigment other than the C.I. pigment green 58.

C.I. pigment green 58 enables excellent brightness to be obtained but is extremely difficult to disperse in a color filter ink in a stable fashion using a conventional method. Also, with conventionally manufactured color filter inks, the droplet discharge stability declines markedly when a colored filter ink containing C.I. pigment green 58 is discharged using an inkjet method. Conversely, with the present invention, even if C.I. pigment green 58 is used (with which it is extremely difficult to obtain stable dispersion using a conventional method), the color filter ink can be endowed with excellent long-term stability of the pigment particles therein and excellent droplet discharge stability. In other words, the effects of the present invention are exhibited more demonstrably when the pigment is C.I. pigment green 58 or C.I. pigment green 58 and a derivative of a pigment other than C.I. pigment green 58 (i.e., a derivative of a pigment having different chemical structure than C.I. pigment green 58).

In the method as described above, the pigment is preferably C.I. pigment blue 15:6 or C.I. pigment blue 15:6 and a derivative of C.I. pigment blue 15.

With such a method, the long-term dispersion stability of the pigment particles in the color filter ink can be made to be particularly excellent.

A color filter ink according to the second aspect is manufactured using the method as described above.

In this way, a color filter ink having excellent dispersion stability of the pigment particles over a long period of time (long-term dispersion stability) can be obtained.

In the color filter ink as described above, it is preferable for the content of the pigment in the color filter ink to be 4.0 to 9.4 wt %, a viscosity of the color filter ink at 25° C. to be 11 mPa-s or smaller, and an amount of change in the viscosity of the color filter ink at 25° C. after the color filter ink has been held at 60° C. for seven days to be 0.5 mPa-s or less.

In this way, the color filter ink can be endowed with particularly excellent discharge stability and color filters reliably prevented from having unevenness of color or saturation can be favorably manufactured with the color filter ink over a longer period of time.

A color filter according to the third aspect is manufactured using the color filter ink as described above.

In this way, it is possible to provide a color filter having excellent durability and excellent uniformity of characteristics between individual units, and in which unevenness of color, saturation, and the like between regions is suppressed.

An image display device according to the fourth aspect is equipped with the color filter as described above.

In this way, it is possible to provide an image display device having excellent durability and excellent uniformity of characteristics between individual units, and in which unevenness of color, saturation, and the like between regions of the display portion is suppressed.

The image display device as described above is preferably a liquid crystal panel.

In this way, it is possible to provide an image display device having excellent durability and excellent uniformity of characteristics between individual units, and in which unevenness of color, saturation, and the like between regions of the display portion is suppressed.

An electronic device according to the fifth aspect is equipped with the image display device as described above.

In this way, it is possible to provide an electronic device having excellent durability and excellent uniformity of characteristics between individual units, and in which unevenness of color, saturation, and the like between regions of the display portion is suppressed.

### BRIEF DESCRIPTION OF THE DRAWINGS

Referring now to the attached drawings which form a part of this original disclosure:

FIG. 1 is a cross-sectional view showing a preferred embodiment of a color filter according to the present invention.

FIG. 2 includes a series of cross-sectional views (1a) to (1e) showing a method for manufacturing a color filter.

FIG. 3 is perspective view showing a droplet discharge device using in the manufacture of the color filter.

FIG. 4 is a view of the droplet discharge means of the droplet discharge device shown in FIG. 3 as seen from the stage.

FIG. 5 is a view showing the bottom surface of the droplet discharge head of the droplet discharge device shown in FIG. 3.

FIG. 6 includes a pair of diagrams (a) and (b) showing a droplet discharge head of the droplet discharge device shown in FIG. 3, wherein FIG. 6 (a) is a cross-sectional perspective view and FIG. 6 (b) is a cross-sectional view.

FIG. 7 is a cross-sectional view showing an embodiment of a liquid crystal display device.

FIG. 8 is a perspective view showing a mobile (or notebook) personal computer exemplifying an electronic device in accordance with the present invention.

FIG. 9 is a perspective view showing a portable telephone (including PHS) exemplifying an electronic device in accordance with the present invention.

FIG. 10 is a perspective view showing a digital still camera exemplifying an electronic device in accordance with the present invention.

### DETAILED DESCRIPTION OF EXEMPLARY EMBODIMENTS

Preferred embodiments of the present invention will now be explained.

First, a preferred embodiment of a method for manufacturing a color filter ink in accordance with the present invention will be explained.

### Method for Manufacturing Color Filter Ink

A method for manufacturing a color filter ink according to the present invention includes a preparatory dispersion step in which a mixture of a dispersing agent, a thermoplastic resin, and a solvent is agitated to disperse the dispersing agent in the solvent and obtain a dispersing-agent-dispersed liquid, a fine dispersing step in which a pigment dispersed material is obtained by adding a pigment to the dispersing-agent-containing dispersion medium and executing a fine dispersion treatment in which inorganic beads are added in multiple stages, and a curable resin mixing step in which the pigment dispersed material is mixed with a curable resin.

### Preparatory Dispersion Step

In the preparatory dispersion step, a mixture of a dispersing agent, a thermoplastic resin, and a solvent is agitated to disperse the dispersing agent in the solvent and obtain a dispersing-agent-dispersed liquid. In this way, the dispersing agent can be put into a state in which it is not associated with itself, i.e., the associations have been broken.

Thus, in the present invention, by preparing a mixture in which the dispersing agent has been dispersed without the pigment before executing a treatment in which the pigment is finely dispersed (described in detail later), the pigment particles are ultimately dispersed in a uniform and stable manner and a color filter ink having particularly excellent discharge stability can be obtained.

### Dispersing Agent

A dispersing agent is a component that helps improve the dispersion of pigment particles in the color filter ink. A dispersing agent is included in the mixture prepared in the preparatory dispersion step, which serves to prepare a dispersing-agent-dispersed liquid (i.e., a liquid in which the dispersing agent is dispersed). During a fine dispersion step that will be described later, the dispersing agent adheres (adsorbs) to the surfaces of pigment particles (pigment particles that are not dispersed and have comparatively large diameters) added to the dispersing-agent-dispersed liquid and enables the pigment particles (pigment particles that are not dispersed and have comparatively large diameters) to achieve an excellent degree of dispersion in the dispersing-agent-dispersed liquid. As a result, the fine dispersion treatment of the fine dispersing step can be executed efficiently and the color filter ink can be manufactured with particularly excellent productivity. Furthermore, the color filter ink ultimately obtained has particularly excellent long-term dispersion stability of the pigment particles (finely dispersed fine pigment particles) in the color filter ink and particularly excellent discharge stability.

There are no particular limitations on the dispersing agent and, for example, a polymer dispersing agent can be used. Examples of polymer dispersing agents include basic polymer dispersing agents, neutral polymer dispersing agents, and acidic polymer dispersing agents. Examples of such polymer dispersing agents include dispersing agents made of an acrylic or modified acrylic copolymer, urethane-based dispersing agents, and dispersing agents made of a polyaminoamide salt, polyether ester, a phosphate ester, or an aliphatic polycarboxylic acid.

More specific examples of dispersing agents that can be used include: Disperbyk 101, Disperbyk 102, Disperbyk 103, Disperbyk P104, Disperbyk P104S, Disperbyk 220S, Disperbyk 106, Disperbyk 108, Disperbyk 109, Disperbyk 110, Disperbyk 111, Disperbyk 112, Disperbyk 116, Disperbyk 140, Disperbyk 142, Disperbyk 160, Disperbyk 161, Disperbyk 162, Disperbyk 163, Disperbyk 164, Disperbyk 166, Disperbyk 167, Disperbyk 168, Disperbyk 170, Disperbyk 171, Disperbyk 174, Disperbyk 180, Disperbyk 182, Disperbyk 183, Disperbyk 184, Disperbyk 185, Disperbyk 2000, Disperbyk 2001, Disperbyk 2050, Disperbyk 2070, Disperbyk 2095, Disperbyk 2150, Disperbyk LPN6919, Disperbyk 9075, and Disperbyk 9077 (all manufactured by BYK Chemie); EFKA 4008, EFKA 4009, EFKA 4010, EFKA 4015, EFKA 4020, EFKA 4046, EFKA 4047, EFKA 4050, EFKA 4055, EFKA 4060, EFKA 4080, EFKA 4400, EFKA 4401, EFKA 4402, EFKA 4403, EFKA 4406, EFKA 4408, EFKA 4300, EFKA 4330, EFKA 4340, EFKA 4015, EFKA 4800, EFKA 5010, EFKA 5065, EFKA 5066, EFKA 5070, EFKA 7500, and EFKA 7554 (all manufactured by Ciba Japan K.K.); Solsperse 3000, Solsperse 9000, Solsperse 13000, Solsperse 16000, Solsperse 17000, Solsperse 18000, Solsperse 20000, Solsperse 21000, Solsperse 24000, Solsperse 26000, Solsperse 27000, Solsperse 28000, Solsperse 32000, Solsperse 32500, Solsperse 32550, Solsperse 33500, Solsperse 35100, Solsperse 35200, Solsperse 36000, Solsperse 36600, Solsperse 38500, Solsperse 41000, Solsperse 41090, and Solsperse 20000 (all manufactured by The Lubrizol Corporation); Ajisper PB-111, Ajisper PB-711, Ajisper PB-821, Ajisper PB-822, and Ajisper PB-824 (all manufactured by Ajinomoto Fine Techno); Disparlon 1850, Disparlon 1860, Disparlon 2150, Disparlon 7004, Disparlon DA-100, Disparlon DA-234, Disparlon DA 325, Disparlon DA-375, Disparlon DA-705, Disparlon DA-725, Disparlon PW-36 (all manufactured by Kusumoto Chemicals); Floren DOPA14, Floren DOPA-1SB, Floren DOPA-17, Floren DOPA-22, Floren DOPA-44, Floren TG-710, and Floren D-90 (all manufactured by Kyoei Kagaku Co., Ltd.); and Anti-Terra-205 (manufactured by BYK Chemie). One or a combination of two or more of these dispersing agents can be used.

In the present invention, it is preferable to use both a dispersing agent having a prescribed acid value (hereinafter called “acid dispersing agent”) and a dispersing agent having a prescribed amine value (hereinafter called “amine dispersing agent”). An acid dispersing agent has an effect of lowering the viscosity of a color filter ink and an amine dispersing agent has an effect of stabilizing the viscosity of a color filter ink. By using both types of dispersing agent, both effects can be utilized to obtain a color filter ink having particularly excellent dispersion stability of the pigment in the color filter ink. Also, a method according to the present invention has a preparatory dispersion step that is conducted before conducting a pigment fine dispersing treatment and in which a mixture containing the dispersing agent(s), the thermoplastic resin, and the solvent is agitated so as to form a dispersing-agent-dispersed liquid in which the dispersing agent is dispersed in the solvent. By using both an acid dispersing agent and an amine dispersing agent in such a method, association of the dispersing agents (i.e., association of the acid dispersing agent and the amine dispersing agent) can be reliably prevented and the dispersion stability of the pigment can be made particularly excellent. Conversely, in a method not having a preparatory dispersion step, the aforementioned effects cannot be obtained by using both an acid dispersing agent and an amine dispersing agent. The reason for this difference is thought to be that when an acid dispersing agent and an amine dispersing agent are used together without executing a preparatory dispersion step, the acid dispersing agent and the amine dispersing agent (which are readily attracted to each other electrically) contact the pigment particles in an associated state, thereby causing the pigment particles to cohere to one another.

Specific examples of an acid dispersing agent include: Disperbyk P104, Disperbyk P104S, Disperbyk 220S, Disperbyk 110, Disperbyk 111, Disperbyk 170, Disperbyk 171, Disperbyk 174, Disperbyk 2095 (all manufactured by BYK Chemie); EFKA 5010, EFKA 5065, EFKA 5066, EFKA 5070, EFKA 7500, and EFKA 7554 (all manufactured by Ciba Japan K.K.); Solsperse 3000, Solsperse 16000, Solsperse 17000, Solsperse 18000, Solsperse 36000, Solsperse 36600, and Solsperse 41000 (all manufactured by The Lubrizol Corporation).

Specific examples of an amine dispersing agent include: Disperbyk 102, Disperbyk 160, Disperbyk 161, Disperbyk 162, Disperbyk 163, Disperbyk 164, Disperbyk 166, Disperbyk 167, Disperbyk 168, Disperbyk 2150, Disperbyk LPN6919, Disperbyk 9075, and Disperbyk 9077 (all manufactured by BYK Chemie); EFKA 4015, EFKA 4020, EFKA 4046, EFKA 4047, EFKA 4050, EFKA 4055, EFKA 4060, EFKA 4080, EFKA 4300, EFKA 4330, EFKA 4340, EFKA 4400, EFKA 4401, EFKA 4402, EFKA 4403, EFKA 4800 (all manufactured by Ciba Japan K.K.); Ajisper PB-711 (manufactured by Ajinomoto Fine Techno); and Anti-Terra-205 (manufactured by BYK Chemie).

When an acid dispersing agent and an amine dispersing agent are used together, there are no particular limitations on the acid value of the acid dispersing agent (acid value calculated based on solid components), but the acid value is preferably from 5 to 370 KOH mg/g, more preferably 20 to 270 KOH mg/g, and still more preferably 30 to 135 KOH mg/g. When the acid value of the acid dispersing agent is within any of these ranges, particularly excellent pigment dispersion stability and discharge stability of the color filter ink can be obtained when the acid dispersing agent is used together with an amine dispersing agent. The acid value of a dispersing agent can be found using a method in compliance with DINENISO2114.

The acid dispersing agent preferably does not have a specific amine value, i.e., the amine value is preferably zero.

When an acid dispersing agent and an amine dispersing agent are used together, there are no particular limitations on the amine value of the amine dispersing agent (amine value calculated based on solid components), but the amine value is preferably from 5 to 200 KOH mg/g, more preferably 25 to 170 KOH mg/g, and still more preferably 30 to 130 KOH mg/g. When the amine value of the amine dispersing agent is within any of these ranges, particularly excellent pigment dispersion stability and discharge stability of the color filter ink can be obtained when the amine dispersing agent is used together with an acid dispersing agent. The amine value of a dispersing agent can be found using a method in compliance with DIN16945.

The amine dispersing agent preferably does not have a specific acid value, i.e., the acid value is preferably zero.

Also, when both an acid dispersing agent and an amine dispersing agent are used, the ratio of the amount acid dispersing agent used to the amount of amine dispersing agent used (amounts calculated based on solid components) in terms of a weight ratio is preferably from 1:1 to 1:9 or, more preferably, 1:2 to 1:5. The dispersion stability of the pigment in the color filter ink and the droplet discharge stability of the color filter ink can thereby be made to be particularly excellent.

The effects of using both an acid dispersing agent and an amine dispersing agent as described above are particularly demonstrative when the color filter ink contains C.I. pigment green 58 and a derivative of a pigment other than C.I. pigment green 58 as pigments.

Although there are no particular limitations on the content of dispersing agent in the dispersing-agent-dispersed liquid that is made in this step (when more than one type of dispersing agent is used, the “content” mentioned here is the sum of the individual contents of the different dispersing agents), the content of dispersing agent is preferably from 10 to 40 wt % or, more preferably, 12 to 32 wt %. If the content of dispersing agent is a value within one of these ranges, the previously described effects will be exhibited more demonstrably.

### Thermoplastic Resin

By using a thermoplastic resin with the dispersing agent(s) in the preparatory dispersion step, the associated state of the dispersing agent(s) can be efficiently broken (the dispersing agent(s) can be broken apart efficiently). Additionally, in the fine dispersion step, the pigment particles can be reliably prevented from cohering to one another again after once having been broken into fine particles and, thus, the pigment particles can be efficiently and reliably broken into fine particles. The long-term dispersion stability of the pigment particles in the color filter ink ultimately obtained and the droplet discharge stability of the color filter ink can also be made to be particularly excellent. Furthermore, the color filter ink can be manufactured with excellent productivity. These effects are obtained when a thermoplastic resin is used and not when a curable resin is used. If, for example, a curable resin is used instead of a thermoplastic resin, then the resin (curable resin) will partially cure due to the energy imparted in order to disperse the dispersing agent in the preparatory dispersing step and the energy imparted in order to finely break the pigment particles in the fine dispersion step and it will not be possible to obtain a color filter having the desired characteristics. More specifically, the viscosity of the color filter ink will be high and the droplet discharge characteristics and discharge stability of the color filter ink will be extremely poor. Also, even if a color filter ink that can be droplet-discharged using an inkjet method is successfully manufactured, a color filter manufactured using the color filter ink will have obvious unevenness of color and saturation.

Examples of thermoplastic resins that can be used include alginate-based resin, polyvinyl alcohol, hydroxypropyl cellulose, carboxymethyl cellulose, hydroxyethyl cellulose, methyl cellulose, styrene-acrylate resin, styrene-acrylate acrylate-ester resin, styrene-maleate resin, styrene-maleate half-ester resin, methacrylate-methacrylic acid ester, acrylate-acrylic acid ester resin, isobutylene-maleic acid resin, rosin modified maleic acid resin, polyvinyl pyrrolidone, gum arabic starch, polyarylamine, polyvinyl amine, and polyethyl amine. One of these or a combination of two or more of these can be used.

Although there are no particular restrictions on the content of thermoplastic resin in the dispersing-agent-dispersed liquid that is made in this step, the content of thermoplastic resin is preferably 6 to 30 wt % or, more preferably, 8 to 26 wt %. If the content of thermoplastic resin is a value within one of these ranges, the previously described effects will be exhibited more demonstrably.

### Solvent

The solvent functions as a solvent serving to dissolve the thermoplastic resin in the dispersing-agent-dispersed liquid and, normally, functions as a dispersion medium for dispersing the pigment in the color filter ink ultimately obtained.

In the present invention, it is preferable to use a water soluble solvent. When the solvent is a water soluble solvent, the dispersing agent described later can be endowed with particularly excellent dispersion properties. A hydrophilic solvent can be used as the water soluble solvent. More specifically, a liquid having a solubility of at least 3 g per 100 g of water at 25° C. can be used as the water soluble solvent.

Examples of water-soluble organic solvents include: ethanol, methanol, butanol, propanol, isopropanol and other alkyl alcohols having one to four carbons; ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, diethylene glycol mono-n-butyl ether, triethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, dipropylene glycol mono-n-propyl ether, dipropylene glycol mono-iso-propyl ether, propylene glycol mono-n-butyl ether, dipropylene glycol mono-n-butyl ether, and other glycol ethers; formamide; acetoamide; dimethyl sulfoxide; sorbit; sorbitan; acetin; diacetin; triacetin; and sulfolane. One or a combination of two or more of these solvents can be used.

In the present invention, a water-soluble organic solvent having a high boiling point of 180° C. or higher can be used in order to prevent unwanted variation of the viscosity of the color filter ink resulting from evaporation of the solvent while the color filter ink is stored. Using such a solvent also enables an appropriate wetness to be maintained, thereby reliably preventing the color filter ink from clogging the nozzle of a droplet discharge device in which the color filter ink is used and enabling a particularly excellent droplet discharge stability to be obtained.

Specific examples of water-soluble organic solvents having a boiling point of 180° C. include: ethylene glycol, propylene glycol, diethylene glycol, pentamethylene glycol, trimethylene glycol, 2-butene-1,4-diol, 2-ethyl-1,3-hexanediol, 2-methyl-2,4-pentanediol, tripropylene glycol monomethyl ether, dipropylene glycol monoethyl glycol, dipropylene glycol monoethyl ether, dipropylene glycol monomethyl ether, dipropylene glycol, triethylene glycol monomethyl ether, tetraethylene glycol, triethylene glycol, diethylene glycol monobutyl ether, diethylene glycol monoethyl ether, diethylene glycol monomethyl ether, tripropylene glycol, polyethylene glycol having a molecular weight of 2000 or smaller, 1,3-propylene glycol, isopropylene glycol, isobutylene glycol, 1,4-butanediol, 1,3-pentanediol, 1,5-pentanediol, 1,6-hexanediol, glycerin, meso-erythritol, penta-erythritol, 1,3-butylene glycol diacetate and diethylene glycol dibutyl ether, diethylene glycol monobutyl ether acetate. One or a combination of two or more of these solvents can be used. Among these organic solvents having a high boiling point, it is preferable for the solvent to contain one or more selected from the group consisting of 1,3-butylene glycol diacetate, diethylene glycol dibutyl ether, and diethylene glycol monobutyl ether acetate. In this way, the long-term dispersion stability of the pigment particles in the color filter ink and the droplet discharge stability of the color filter ink can be made to be particularly excellent. Even if the content of pigment in the color filter ink ultimately obtained is high, the long-term dispersion stability of the pigment in the color filter ink and the discharge stability of the color filter ink can be made to be sufficiently excellent. Furthermore, the color filter ink can be manufactured with good efficiency and with particularly excellent productivity. These effects are exhibited more demonstrably when 1,3-butylene glycol diacetate and diethylene glycol monobutyl ether acetate are selected from among 1,3-butylene glycol diacetate, diethylene glycol dibutyl ether, and diethylene glycol monobutyl ether acetate.

Although there are no particular restrictions on the content of solvent in the dispersing-agent-dispersed liquid that is made in this step, the content of solvent is preferably 40 to 80 wt % or, more preferably, 53 to 75 wt %. If the content of solvent is a value within one of these ranges, the previously described effects will be exhibited more demonstrably.

Although there are no particular limits on the amount of solvent used, the content of solvent per 100 parts by weight of pigment in the color filter ink ultimately obtained is preferably 100 to 500 parts by weight, more preferably 100 to 300 parts by weight, and still more preferably 100 to 200 parts by weight. If the amount of solvent is too small, then it can be difficult to disperse the pigment particles in a uniform manner in the fine dispersion step discussed later. Meanwhile, if the amount of solvent in the color filter ink ultimately obtained is too large, then it will be difficult to form a colored portion having sufficient strength using the color filter ink.

In this step, various types of agitating machines are used to agitate the mixture of the aforementioned components so as to obtain a dispersing-agent-dispersed liquid. An example of an agitating machine that can be used in this step is a single-axis or dual-axis mixer, such as a dispermill. Although there are no particular limitations on the amount of time the agitating machine is used to execute the agitation treatment, the amount of time is preferably 1 to 30 minutes or, more preferably, 3 to 20 minutes. In this way, the color filter ink can be manufactured with sufficiently excellent productivity and the associated state of the dispersing agent(s) can be broken in an effective manner. The color filter ink ultimately obtained can thereby be endowed with particularly excellent dispersion stability of the pigment particles in the color filter ink and particularly excellent discharge stability of the color filter ink.

Although there are no particular restrictions on the rotational speed of an agitation propeller of the agitating machine used in this step, the rotational speed of the agitation propeller is preferably 500 to 4000 rpm or, more preferably, 800 to 3000 rpm. In this way, the color filter ink can be manufactured with sufficiently excellent productivity and the associated state of the dispersing agent(s) can be broken in an effective manner. The color filter ink ultimately obtained can thereby be endowed with particularly excellent dispersion stability of the pigment particles in the color filter ink and particularly excellent discharge stability of the color filter ink. Furthermore, degradation of the thermoplastic resin due to heat or the like can be reliably prevented.

### Fine Dispersion Step

In the fine dispersion step, a pigment is added to the dispersing-agent-dispersed liquid obtained in the preceding step (preparatory dispersion step) and inorganic beads are added in multiple stages.

In the present embodiment, a preparatory dispersion step is provided before adding the pigment and inorganic beads are added in multiple stages during a step in which the pigment is finely dispersed (fine dispersion step).

In the fine dispersion step, by adding the inorganic beads in multiple stages, the pigment can be broken into fine particles in a very efficient manner and the color filter ink ultimately obtained can be provided with sufficiently small pigment particles. Furthermore, the color filter ink can be endowed with excellent discharge stability.

Conversely, if the fine dispersing step is not conducted in multiple stages, then the effects described above cannot be obtained. More specifically, if the fine dispersing step is not conducted in multiple stages, then the pigment particles in the color filter ink ultimately obtained will not be small enough, the discharge stability of the color filter ink will be poor, and the productivity with which the color filter ink is manufactured will decline markedly. If the processing time of the fine dispersing step is excessively long, then successfully breaking the pigment particles into comparatively small particles will be countered by degradation of the thermoplastic resin and the color filter ink ultimately obtained will not have the desired characteristics. In particular, the color filter ink will not have excellent long-term dispersion of the pigment particles or excellent droplet discharge stability.

Even if the fine dispersion step is executed in multiple stages, problems can occur if the preparatory dispersion step is omitted. If the preparatory dispersion step is omitted, then the associated state of the dispersing agent(s) will not be sufficiently broken (disassociated) when the pigment is added and, consequently, in the fine dispersion step it will be difficult to make the dispersing agent adhere uniformly to the surfaces of the pigment particles. Thus, it will be difficult to achieve a sufficiently excellent dispersion of the pigment particles (comparatively large diameter pigment particles that are not finely dispersed) in the solvent during the fine dispersion step. Consequently, it will be difficult to break the pigment particles into smaller particles and finely disperse the pigment particles in the fine dispersion step. If the processing time of the fine dispersing step is excessively long, then successfully breaking the pigment particles into comparatively small particles will be countered by degradation and denaturalization of the thermoplastic resin and the color filter ink ultimately obtained will not have the desired characteristics. In particular, the color filter ink will not have excellent long-term dispersion of the pigment particles or excellent droplet discharge stability.

In this embodiment, the fine dispersion step is contrived such that the inorganic beads are added in multiple stages. While it is acceptable to add the inorganic beads in three or more stages, it is preferable to add the inorganic beads in two stages. As result, the color filter ink ultimately obtained can be endowed with sufficiently excellent long-term dispersion stability of the pigment particles in the color filter ink and the color filter ink can be manufactured with particularly excellent productivity.

A representative example of a method in which the inorganic beads are added in two stages, i.e., a method having a first treatment in which first inorganic beads are used and a second treatment in which second inorganic beads are used, will now be explained.

The inorganic beads used in this step (first inorganic beads and second inorganic beads) can be made of any inorganic material. A good example of a type of inorganic bead that can be used is a bead made of zirconia (e.g., Torayceram (trade name) pulverizing balls manufactured by Toray Industries, Inc.).

### First Treatment

In this step, first the pigment is added to the dispersing-agent-dispersed liquid made in the previously described preparatory dispersion step and a first treatment constituting a primary dispersion (first dispersion) is executed using first inorganic beads having a prescribed particle diameter.

The first inorganic beads used in the first treatment preferably have a larger diameter than the second inorganic beads used in the second treatment. By using larger beads in the first treatment and smaller beads in the second treatment, the efficiency with which the pigment is pulverized into fine particles (finely dispersed) in the fine dispersion step as a whole can be made to be particularly excellent.

Although there are no particular limitations on the average particle diameter of the first inorganic beads, the average particle diameter is normally 0.5 to 3.0 mm, preferably 0.5 to 2.0 mm, and more preferably 0.5 to 1.2 mm. When the average particle diameter of the first inorganic beads is a value within one of these ranges, the pulverization of the pigments in to fine particles (fine dispersion of the pigments) in the fine dispersion step as a whole can be accomplished with particularly excellent efficiency. Conversely, if the average particle diameter of the first inorganic beads is smaller than the lower limit value of the aforementioned ranges, then depending on the type of pigments used, the efficiency of the pulverization of the pigments into fine particles (size reduction of the pigment particles) in the first treatment will tend to decline demonstrably. Meanwhile, if the average particle diameter of the first inorganic beads is larger than the upper limit value of the aforementioned ranges, the efficiency of the pulverization of the pigments into fine particles (size reduction of the pigment particles) in the first treatment can be comparatively good, but the efficiency of the pulverization of the pigments into fine particles (size reduction of the pigment particles) in the second treatment will decline and cause the overall pulverization (fine dispersion) efficiency of the fine dispersion step to decline.

Although there are no particular limitations on the amount of first inorganic beads used, the amount of first inorganic beads is preferably 100 to 600 parts by weight, and more preferably 200 to 500 parts by weight, for every 100 parts by weight of the dispersing-agent-dispersed liquid.

The pigment added to the dispersing-agent-dispersed liquid in this step can be any of various organic and inorganic pigments, but it is preferable to use an organic pigment. By using an organic pigment, a color filter made with the color filter ink can be endowed with particularly excellent coloration and contrast. Examples of organic pigments that can be used include compounds categorized as “pigments” in the Color Index (C.I., The Society of Dyer and Colourists). More specifically, compounds having the following Color Index (C.I.) numbers can be used: C.I. pigment yellows 1, 3, 12, 13, 14, 15, 16, 17, 20, 24, 31, 55, 60, 61, 65, 71, 73, 74, 81, 83, 93, 95, 97, 98, 100, 101, 104, 106, 108, 109, 110, 113, 114, 116, 117, 119, 120, 126, 127, 128, 129, 138, 139, 150, 151, 152, 153, 154, 155, 156, 166, 168, 175; C.I. pigment oranges 1, 5, 13, 14, 16, 17, 24, 34, 36, 38, 40, 43, 46, 49, 51, 61, 63, 64, 71, 73; C.I. pigment violets 1, 19, 23, 29, 32, 36, 38; C.I. pigment reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48:1, 48:2, 48:3, 48:4, 49:1, 49:2, 50:1, 52:1, 53:1, 57, 57:1, 57:2, 58:2, 58:4, 60:1, 63:1; 63:2, 64:1, 81:1, 83, 88, 90:1, 97, 101, 102, 104, 105, 106, 108, 112, 13, 114, 122, 123, 144, 146, 149, 150,151, 166, 168, 170, 171, 172, 174, 175, 176, 177, 178, 179, 180, 185, 187, 188, 190, 193, 194, 202, 206, 207, 208, 209, 215, 216, 220, 224, 226, 242, 243, 245, 254, 255, 264, 265; C.I. pigment blues 15, 15:3, 15:4, 15:6, 60; C.I. pigment greens 7, 36, 58; C.I. pigment browns 23, 25; C.I. pigment blacks 1 and 7; and derivatives of any of these. One or a combination of two or more of these pigments can be used.

In particular, a red color filter ink having excellent coloration properties can be obtained by using C.I. pigment red 177, C.I. pigment red 177 and a derivative thereof, C.I. pigment red 254, or C.I. pigment red 254 and a derivative thereof, C.I. pigment red 177 and a derivative thereof or C.I. pigment red 254 and a derivative thereof being particularly preferable. The long-term dispersion stability of the pigment particles in the color filter ink and the droplet discharge stability of the color filter ink can also be made to be particularly excellent.

For example, if a pigment (red pigment) containing a compound (derivative) in accordance with Formula (I) or Formula (II) below, the pigment particles can be finely dispersed with particularly good efficiency using a manufacturing method according to the present invention and a color filter ink in which the pigment particles have particularly excellent long-term dispersion stability can be obtained.

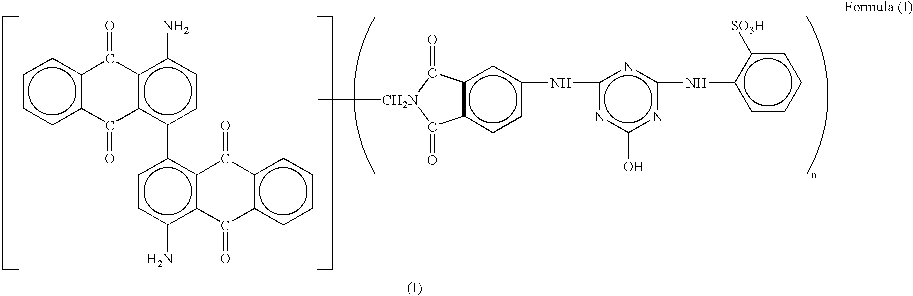

In Formula (I), n is an integer from 1 to 4.

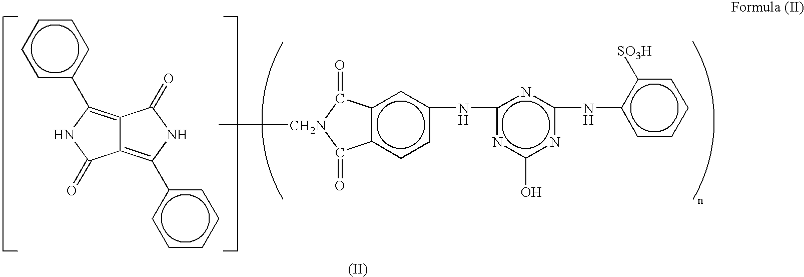

In Formula (II), n is an integer from 1 to 4.

A green color filter ink having excellent coloration properties can be obtained by using C.I. pigment green 58 (zinc bromide phthalocyanine pigment) or C.I. pigment green 58 and a derivative of a pigment other than C.I. pigment green 58 (a derivative of a pigment having different chemical structure than C.I. pigment green 58). C.I. pigment green 58 enables excellent lightness to be obtained but is extremely difficult to disperse in a color filter ink in a stable fashion using a conventional method. Also, with conventionally manufactured color filter inks, the droplet discharge stability declines markedly when a colored filter ink containing C.I. pigment green 58 is discharged using an inkjet method. Conversely, with the present invention, the color filter ink can be endowed with excellent long-term stability of the pigment particles therein and excellent droplet discharge stability even if the color filter ink contains C.I. pigment green 58 (with which it is extremely difficult to obtain stable dispersion using a conventional method). In other words, the effects of the present invention are exhibited more demonstrably when the pigment is C.I. pigment green 58 or C.I. pigment green 58 and a derivative of a pigment other than C.I. pigment green 58 (i.e., a derivative of a pigment having different chemical structure than C.I. pigment green 58). These effects are exhibited particularly demonstrably when the pigment is C.I. pigment green 58 and a derivative of a pigment other than C.I. pigment green 58.

When the pigment is C.I. pigment green 58 and a derivative of a pigment other than C.I. pigment green 58, it is preferable for the derivative of the pigment other than C.I. pigment green 58 to contain a compound (derivative) expressed by Formula (III) below. Thus, with a manufacturing method according to the present invention, the pigment particles can be dispersed with particularly excellent efficiency and the color filter ink can be endowed with particularly excellent long-term dispersion of the pigment particles and particular excellent droplet discharge stability.

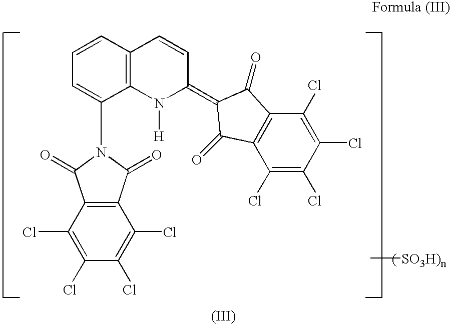

In Formula (III), n is an integer from 1 to 5.

A blue color filter ink having excellent coloration can be obtained by using C.I. pigment blue 15:6 and a derivative of C.I. pigment blue 15 as pigments. With such a blue color filter ink, the long-term dispersion stability of the pigment particles in the color filter ink and the droplet discharge stability of the color filter ink can also be made to be particularly excellent. These effects are exhibited particularly demonstrably when the pigment is C.I. pigment blue 15:6 and a derivative of C.I. pigment blue 15.

Although there are no particular limitations on the amount of pigment used when the pigment is added to the dispersing-agent-dispersed liquid, the amount of pigment is preferably 12 or more parts by weight, and more preferably 18 to 35 parts by weight, for every 100 parts by weight of the dispersing-agent-dispersed liquid.

The first treatment can be accomplished by adding the first inorganic beads to the dispersing-agent-dispersed liquid and agitating the mixture with any of various agitating machines.

Examples of agitating machines that can be used in the first treatment include such media dispersing machines as a Pearl Mill and such single axis or dual axis mixers as a dispermill.

Although there are no particular limitations on the amount of time the agitating machine is used to execute the agitation treatment (first treatment), the amount of time is preferably 10 to 120 minutes or, more preferably, 15 to 40 minutes. As a result, the pigment can be pulverized into fine particles (finely dispersed) efficiently without decreasing the productivity with which the color filter ink is manufactured.

Although there are no particular restrictions on the rotational speed of an agitation propeller of the agitating machine used in the first treatment, the rotational speed of the agitation propeller is preferably 1000 to 5000 rpm or, more preferably, 1200 to 3800 rpm. With such a rotational speed, the pigment can be pulverized into fine particles (finely dispersed) efficiently without decreasing the productivity with which the color filter ink is manufactured. Furthermore, degradation and denaturalization of the thermoplastic resin due to heat or the like can be reliably prevented.

### Second Treatment

After the first treatment, the second treatment including a second dispersion is executed using the second inorganic beads. In this way, a pigment dispersed material in which the pigment particles are sufficiently dispersed can be obtained.

Although it is acceptable to execute the second treatment with the first inorganic beads remaining in the mixture, it is preferable to remove the first inorganic beads before executing the second treatment. By removing the first inorganic beads, the efficiency with which the pigments are pulverized into fine particles (finely dispersed) in the second treatment can be made to be particularly excellent. The first inorganic beads can be removed easily and reliably by, for example, filtering.

The second inorganic beads used in the second treatment preferably have a smaller diameter than the first inorganic beads used in the first treatment. In this way, the pigments can be sufficiently pulverized into fine particles (finely dispersed) in the color filter ink ultimately obtained, and the color filter ink can be endowed with particularly excellent dispersion stability (long-term dispersion stability) of the ink particles over a long period time and particularly excellent droplet discharge stability.

Although there are no particular limitations on the average diameter of the second inorganic beads, the average diameter is preferably from 0.03 to 0.3 mm, and more preferably from 0.05 to 0.2 mm. When the average particle diameter of the second inorganic beads is a value within one of these ranges, the pulverization of the pigments into fine particles (fine dispersion of the pigments) in the fine dispersion step as a whole can be accomplished with particularly excellent efficiency. Conversely, if the average particle size of the second inorganic beads is smaller than the lower limit value of the aforementioned ranges, then depending on the type of pigments used, the efficiency of the pulverization of the pigments in to fine particles (size reduction of the pigment particles) in the second treatment will tend to decline demonstrably. Meanwhile, if the average particle diameter of the second inorganic beads is larger than the upper limit of the aforementioned ranges, then it can be difficult to sufficiently pulverize the pigments into fine particles (reduce the size of the pigment particles).

Although there are no particular limitations on the amount of second inorganic beads used, the amount of second inorganic beads is preferably 100 to 600 parts by weight, and more preferably 200 to 500 parts by weight, for every 100 parts by weight of the dispersing-agent-dispersed liquid.

The second treatment can be accomplished using any of various agitating machines.

Examples of agitating machines that can be used in the second treatment include such media dispersing machines as a Pearl Mill and such single axis or dual axis mixers as a dispermill.

Although there are no particular limitations on the amount of time the agitation machine is used to execute the agitation treatment (second treatment), the amount o time is preferably 10 to 120 minutes or, more preferably, 15 to 40 minutes. As a result, the pigment can be sufficiently pulverized into fine particles (finely dispersed) without decreasing the productivity with which the color filter ink is manufactured.

Although there are no particular restrictions on the rotational speed of an agitation propeller of the agitating machine used in the second treatment, the rotational speed of the agitation propeller is preferably 1000 to 5000 rpm or, more preferably, 1200 to 3800 rpm. With such a rotational speed, the pigment can be pulverized into fine particles (finely dispersed) efficiently without decreasing the productivity with which the color filter ink is manufactured. Furthermore, degradation and denaturalization of the thermoplastic resin due to heat or the like can be reliably prevented.

Although fine dispersion treatment is explained based on a case in which the fine dispersion treatment is executed in two stages, it is also acceptable to execute a treatment having three or more stages. In such a case, it is preferable for the inorganic beads used in later treatments to be smaller than the inorganic beads used in earlier treatments. In other words, it is preferable for the average particle diameter of the inorganic beads (n^{th} inorganic beads) used in the n^{th} treatment to be smaller than the average particle diameter of the inorganic beads ((n−1)^{th} inorganic beads) used in the (n−1)^{th} treatment. By satisfying this relationship, the pigment particles can be pulverized to a finer size (finely dispersed) in a particularly efficient manner and the color filter ink ultimately obtained can be endowed with smaller pigment particles.

In the fine dispersion step (e.g., the first treatment and the second treatment), it is acceptable to execute, for example, a dilution treatment using a solvent as necessary.

### Curable Resin Mixing Step

In the curable resin mixing step, the pigment dispersed material obtained in the fine dispersing step is mixed with a curable resin.

It is preferable for the second inorganic beads used in the second treatment to be removed before executing this step. The second inorganic beads can be removed easily and reliably by, for example, filtering.

Curable resins that can be used include, for example, various heat-curable resins and light-curable resins that can be cured by being irradiated with energy rays.

In particular, when an epoxy resin is used as the curable resin, effects that will now be explained can be obtained. Since epoxy resins have high transparency and high hardness and do not shrink much due to heat, a colored portion having particularly excellent adhesion to the substrate can be obtained. The long-term dispersion stability of the pigment particles in the color filter ink can be made particularly excellent by using an epoxy resin having a silyl acetate structure (SiOCOCH3) and an epoxy structure as the curable resin of the color filter ink. In particular, the long-term dispersion stability of the pigment particles is excellent when the color filter ink is kept at a high temperature. Additionally, the discharge stability of the color filter ink is particularly excellent and a color filter manufactured using the color filter ink can be used to display an image having particularly excellent contrast.

The content of the curable resin material is preferably 15 to 50 parts by weight or, more preferably, 19 to 42 parts by weight for every 100 parts by weight of pigment. When the amount of curable resin used is within these ranges, a colored portion having particularly excellent coloration and contrast can be formed on a color filter using the color filter ink. Also, a colored portion formed using the color filter ink can be endowed with particularly excellent adhesion to the substrate.

The curable resin mixing step can be accomplished using any of various agitating machines.

An example of an agitating machine that can be used in this step is a single-axis or dual-axis mixer, such as a dispermill.

Although there are no particular limitations on the amount of time the agitation machine is used to execute the agitation treatment (to execute this step), the amount o time is preferably 1 to 60 minutes or, more preferably, 15 to 40 minutes.

Although there are no particular restrictions on the rotational speed of an agitation propeller of the agitating machine used in this step, the rotational speed of the agitation propeller is preferably 1000 to 5000 rpm or, more preferably, 1200 to 3800 rpm.

In this step, it is acceptable to add a liquid of a different composition than the solvent used in the previous steps. In this way, the dispersing agent can be dispersed in a favorable fashion in the preparatory dispersion step and the pigment particles can be dispersed in a favorable fashion in the fine dispersion step. Meanwhile, a color filter ink having the desired properties can be obtained in a reliable fashion in this step.

In this step, it is acceptable to remove at least a portion of the solvent used in the preceding steps before or after the curable resin is mixed with the pigment dispersed material. In this way, the composition of the dispersion medium of the color filter ink ultimately obtained can be made to be different from the composition of the solvent used in the preparatory dispersion step and the fine dispersion step. As a result, the dispersing agent can be dispersed in a favorable fashion in the preparatory dispersion step and the pigment particles can be dispersed in a favorable fashion in the fine dispersion step. Meanwhile, a color filter ink having the desired properties can be obtained in a reliable fashion in this step. The solvent can be removed by, for example, putting the targeted liquid into an atmosphere of reduced pressure and heating it.

### Color Filter Ink

Using the method described above, a color filter ink in accordance with the present invention is obtained.

In a color filter ink according to the present invention, the pigment particles are finely dispersed in a uniform fashion, the dispersion stability of the pigment particles over a long period of time (long-term dispersion stability) is excellent, and the droplet discharge stability of the color filter ink is excellent. Consequently, changes in the properties of the color filter ink over time can be prevented in an effective manner such that stable droplet discharging can be conducted over a long period of time and uniform color filters can be mass produced. Furthermore, unevenness of color and saturation between regions can be reliably prevented even when large color filter substrates are manufactured. Also, since the pigment particles are finely dispersed, the coloration of the pigment is excellent and a colored portion having high contrast and high lightness can be formed.

Although there are no particular limitations on the average particle size (diameter) of the pigment particles in the color filter ink, the average particle size is preferably from 10 to 200 nm or, more preferably, from 20 to 180 nm. With such an average pigment particle size, the dispersion stability of the pigment in the color filter ink is excellent and a color filter having sufficiently excellent light fastness and superior coloration can be manufactured using the color filter ink.

It is preferable for the content of pigment in the color filter ink to be from 3 to 25 wt %, more preferable for the same to be from 3.5 to 20 wt %, and still more preferable for the same to be from 4.0 to 9.4%. When the content of pigments is within any of these ranges, a color filter having a higher color saturation can be manufactured using the color filter ink and a sharper display image can be obtained using the color filter. When a conventional color filter ink contains a comparatively high concentration of pigment, the discharge stability is particularly low and flight deflection, instability of the droplet discharge quantity, and other problems occur particularly easily during discharging of the color filter ink. Furthermore, with a conventional color filter ink, particularly when droplet discharging of the color filter ink is executed in order to form a color portion on a large substrate (e.g., G5 or larger), the occurrence of bad products (rejected filters) is high due to variation of the discharge amount among different locations on the surface and the level of productivity with which the color filters can be manufactured declines markedly. Conversely, with the present invention, even when the color filter ink contains a relatively high concentration of pigment, such problems as those described above can be reliably prevented from occurring. Unevenness of color and saturation among different locations of a manufactured color filter and variation of characteristics between individual units can be reliably prevented, and color filters can be manufactured with excellent productivity, as will be described in detail later. In short, the effects of the present invention are more clearly demonstrated when the color filter ink contains a comparatively high concentration of pigment, as described above. The present invention also enables a color filter having excellent durability to be manufactured.

The content ratio of the curable resin in the color filter ink is preferably 0.5 to 10 wt %, and more preferably 1 to 5 wt %. When the content ratio of the curable resin is within this range, the color filter ink with can be endowed with excellent discharge stability from the droplet discharge head and a color filter manufactured using the color filter ink can be endowed with particularly excellent durability. Adequate color saturation can also be ensured in a manufactured color filter.

The viscosity of the color filter ink at 25° C. (viscosity (kinematic viscosity) measured using an E-type viscometer) is preferably 14 mPa-s or below, more preferably 12 mPa-s or below, and still more preferably from 8 to 11 mPa-s. If the viscosity (kinematic viscosity) of the color filter ink is sufficiently low, then, for example, color filters can be manufactured with particularly excellent production efficiency (colored portions can be formed very efficiently) and unintended variation of the thickness of colored portions formed can be effectively prevented. The viscosity (kinematic viscosity) of the color filter ink can be measured using, for example, an E-type viscometer (e.g., an RE-01 manufactured by Toki Sangyo Co., Ltd.); more particularly, the viscosity can be measured in accordance with JIS Z8809.

The color filter ink is contrived such that after it has been held at 60° C. for seven days, its viscosity at 25° C. is preferably 0.5 mPa-s or lower, more preferably 0.3 mPa-s, and still more preferably for 0.2 mPa-s. In this way, the color filter ink can be endowed with particularly excellent discharge stability and color filters reliably prevented from having unevenness of color or saturation can be favorably manufactured with the color filter ink over a longer period of time.

While a color filter ink according to the present invention contains a pigment, a dispersing agent, a thermoplastic resin, and a solvent (dispersing medium), it is also acceptable for the color filter ink to contain other components if necessary. Examples of such components include dyes, cross-linking agents, polymerization accelerators, antioxidants, UV absorbers, and photostabilizers.

### Ink Set

A color filter ink such as that described above is used in the manufacture of a color filter using an inkjet method. A color filter ordinarily has a plurality of colored portions of different colors (ordinarily, the three colors red, green, and blue corresponding to the three primary colors of light) in order to accommodate a full color display. In order to form the different colored portions, a plurality of types of color filter ink corresponding to each of the colors of the colored portions is used. In other words, an ink set provided with a plurality of colors of color filter ink is used in the manufacture of a color filter. In the present invention, a color filter ink such as that described above is used in the formation of at least one colored portion in the manufacture of a color filter, but a color filter ink such as that described above is preferably used in the formation of all colors of colored portions. When all of the inks (color filter inks) forming the color filter ink set are color filter inks according to the present invention, variation of the droplet discharge stability among the different colors can be suppressed to a higher degree and a more reliable color filter can be manufactured.

### Color Filter

Following is a description of an example of a color filter manufactured using the color filter ink (ink set) described above.

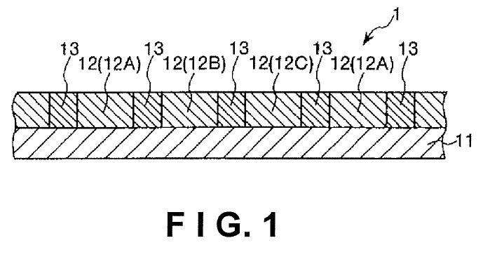

FIG. 1 is a cross-sectional view showing a preferred embodiment of a color filter in accordance with the present invention.

As shown in FIG. 1, the color filter 1 comprises a substrate 11 and colored portions 12 formed using the color filter inks described previously. The colored portions 12 include a first colored portion 12A, a second colored portion 12B, and a third colored portion 12C, each having a different color. A partition wall 13 is disposed between adjacent colored portions 12.

### Substrate

The substrate 11 is a plate-shaped member having optical transparency and a function of holding the colored portions 12 and the partition walls 13.

It is preferred that the substrate 11 be essentially composed of a transparent material. A clearer image can thereby be formed by light transmitted through the color filter 1.

The substrate 11 preferably has excellent heat resistance and mechanical strength. Deformations or the like caused by, for example, heat applied during the manufacture of the color filter 1 can thereby be reliably prevented. Examples of a constituent material of the substrate 11 that satisfies such conditions include glass, silicon, polycarbonate, polyester, aromatic polyamide, polyamidoimide, polyimide, norbornene-based ring-opening polymers, and hydrogenated substances.

### Colored Portions

The colored portions 12 are formed using a color filter ink such as that described above.

Since the colored portions 12 are formed using a color filter ink such as that described above, there is little variation in characteristics between pixels and unintentional color mixing (mixing of a plurality of color filter inks) and the like is reliably prevented. For this reason, the color filter 1 is highly reliable in that the occurrence of unevenness of color and saturation is reduced. Additionally, the colored portions 12 have excellent coloration and the color filter 1 has excellent contrast.

Each colored portion 12 is disposed inside a cell 14, which is an area enclosed by a partition wall 13 (described later).

The first colored portion 12A, the second colored portion 12B, and the third colored portion 12C each have a different color. For example, the first colored portion 12A can be a red filter area (R), second colored portion 12B can be a green filter area (G), and the third colored portion 12C can be a blue filter area (B). Each set of different-colored colored portions 12A, 12B, 12C constitutes a single pixel. In a colored filter 1, prescribed numbers of colored portions 12 are arranged in the horizontal and vertical directions. For example, the color filter 1 has 1366×768 pixels if it is a high vision color filter, 1920×1080 pixels if it is a full high vision color filter, and 7680×4320 pixels if it is a super high vision color filter. The color filter 1 may be provided with spare pixels outside of an effective area.

### Partition Wall

A partition wall (bank) 13 is disposed between adjacent colored portions 12. As a result, color mixing between adjacent colored portions 12 can be reliably prevented and a clear image can be displayed in a reliable fashion.

The partition wall 13 may be composed of a transparent material, but it is preferably composed of material having light-blocking properties. Using such a material enables an image with excellent contrast to be displayed. The color of the partition wall (light-blocking portion) 13 is not particularly limited, but black is preferred. Using black partition walls enables a displayed image having particularly good contrast to be obtained.

Although there are no particular limits on the height of the partition walls 13, the height is preferably larger than the film thickness of the colored portions 12. By making the height of the partition walls 13 larger than the film thickness, mixing of colors between adjacent colored portions 12 can be reliably prevented. The thickness of the partition walls 13 is preferably from 0.1 to 10 μm, and more preferably 0.5 to 3.5 μm. When the wall thickness is within these ranges, mixing of colors between adjacent colored portions 12 can be reliably prevented and an image display device or electronic device equipped with the color filter 1 can be endowed with an excellent viewing angle characteristic.

The partition wall 13 may be composed of any material, but is preferably composed principally of a resin material, for example. In this way, a partition wall 13 having a desired shape can be easily formed using a method described hereinafter. When the partition wall 13 will function as a light-blocking portion, carbon black or another light-absorbing material may be included as a constituent material of the partition wall.

### Method for Manufacturing Color Filter

Next, an example of the method for manufacturing the color filter 1 will be described.

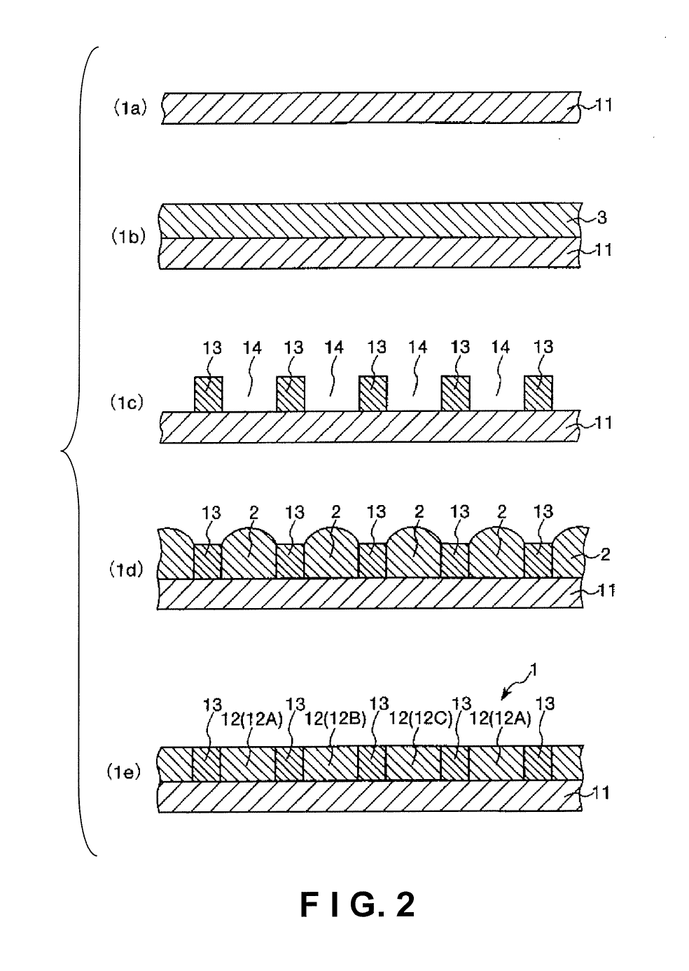

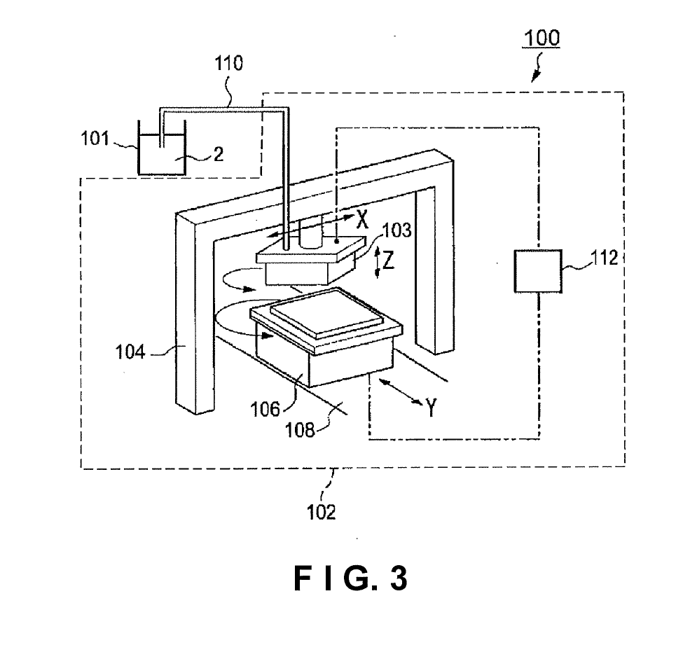

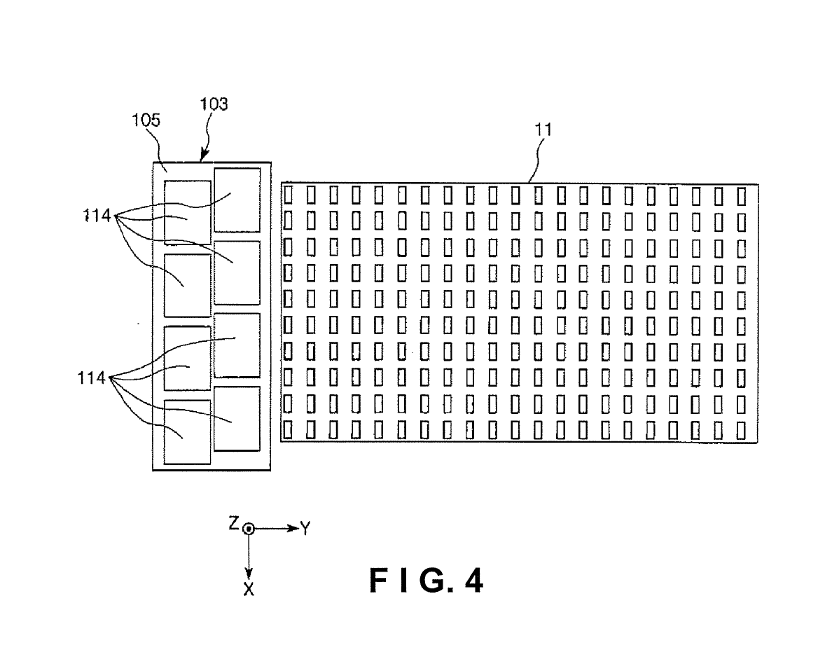

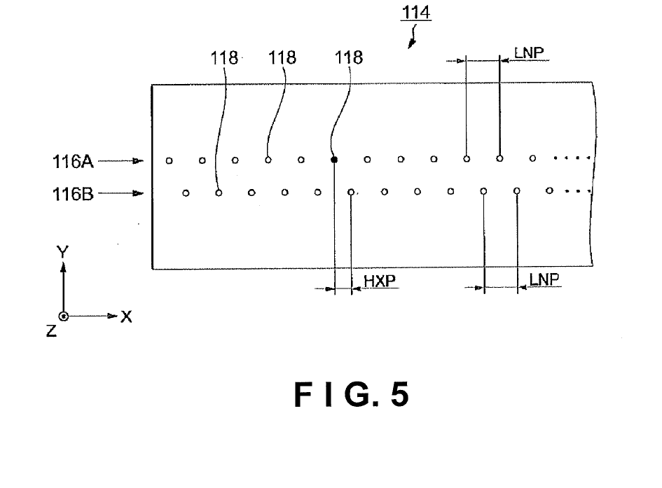

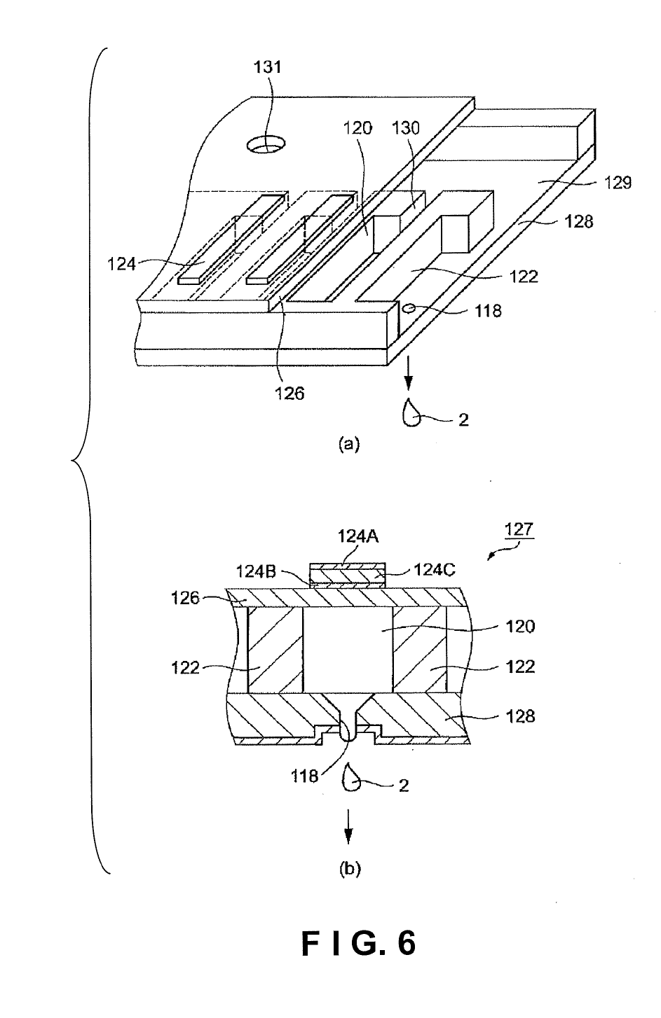

FIG. 2 is a cross-sectional view showing a method for manufacturing a color filter; FIG. 3 is a perspective view showing the droplet discharge device used in the manufacture of the color filter; FIG. 4 is a view of a droplet discharge means in the droplet discharge device shown in FIG. 3, as seen from the stage side; FIG. 5 is a view showing the bottom surface of the droplet discharge head in the droplet discharge device shown in FIG. 3; and FIG. 6 is a view showing the droplet discharge head in the droplet discharge device shown in FIG. 3, wherein FIG. 6 (a) is a cross-sectional perspective view and FIG. 6 (b) is a cross-sectional view.

The present embodiment has a substrate preparation step (1a) for preparing a substrate 11, a partition wall formation step (1b, 1c) for forming a partition wall 13 on the substrate 11, an ink application step (1d) for applying color filter ink 2 into an area surrounded by the partition wall 13 by using an inkjet method, and a colored portion formation step (1e) for forming solid colored portions 12 by removing liquid medium from the color filter ink 2 and curing the curable resin, as shown in FIG. 2.

### Substrate Preparation Step

First, a substrate 11 is prepared (1a). It is preferred that the substrate 11 to be prepared in the present step undergo a washing treatment. The substrate 11 to be prepared in the present step may be washed by chemical treatment using a silane-coupling agent or the like, a plasma treatment, ion plating, sputtering, gas phase reaction, vacuum deposition, or another suitable washing treatment.

### Partition Wall Formation Step

Next, a radiation-sensitive composition is applied to substantially the entire surface of one of the surfaces of the substrate 11 to form (1b) a coated film 3. A pre-baking treatment may be performed as required after the radiation-sensitive composition has been applied to the substrate 11. The pre-baking treatment may be carried out under the conditions of, for example, a heating temperature of 50 to 150° C. and a heating time of 30 to 600 seconds.

Next, a partition wall 13 is formed (1c) by irradiating the radiation-sensitive composition via a photomask, performing a post exposure bake (PEB) treatment, and carrying out a development treatment using an alkaline liquid developer. PEB can be carried out at, for example, a heating temperature of 50 to 150° C., a heating time of 30 to 600 seconds, and an irradiation intensity of 1 to 500 mJ/cm². The development treatment can be accomplished using, for example, a fluid overflow method, a dipping method, a vibration soaking method, or the like, and the development treatment time can be set to 10 to 300 seconds, for example. After the development treatment, a post-baking treatment may be performed as required. The post-baking treatment can be carried out at, for example, a heating temperature of 150 to 280° C. and a heating time of 3 to 120 minutes.

### Ink Application Step

Next, the color filter ink 2 is applied (1d) to the cells 14 surrounded by the partition wall 13 using the inkjet method.

The present step is carried out using a plurality of types of color filter inks 2 that correspond to the plurality of colors of the colored portions 12 to be formed. Since a partition wall 13 is provided, mixing of two or more color filter inks 2 can be reliably prevented.

The color filter ink 2 is discharged using a droplet discharge device such as that shown in FIGS. 3 to 6.

The droplet discharge device 100 used in the present step is provided with a tank 101 for holding the color filter ink 2, a tube 110, and a discharge scan unit 102 to which the color filter ink 2 is fed from the tank 101 via the tube 110, as shown in FIG. 3. The discharge scan unit 102 is provided with droplet discharge means 103 having a plurality droplet discharge heads (inkjet heads) 114 mounted on a carriage 105, a first position control device 104 (movement means) for controlling the position of the droplet discharge means 103, a stage 106 for holding a substrate 11 on which partition walls 13 have been formed in the aforementioned step (hereinafter simply referred to as “substrate 11”), a second position control device 108 (movement means) for controlling the position of the stage 106, and a controller 112. The tank 101 and the droplet discharge heads 114 of the droplet discharge means 103 are connected by the tube 110, and the color filter ink 2 is fed from the tank 101 to each of the droplet discharge heads 114 with compressed air.

The first position control device 104 is contrived to move the droplet discharge means 103 along an X-axis direction and a Z-axis direction that is orthogonal to the X-axis direction in accordance with a signal from the controller 112. The first position control device 104 also functions to rotate the droplet discharge means 103 about an axis parallel to the Z-axis. In this embodiment, the Z-axis is oriented in a vertical direction (i.e., a direction of acceleration due to gravity). The second position control device 108 is contrived move the stage 106 along a Y-axis direction that is orthogonal to the X-axis direction and the Z-axis direction in accordance with a signal from the controller 112. The second position controller 108 also functions to rotate the stage 106 about an axis parallel to the Z-axis.

The stage 106 has a flat surface that is parallel to both the X-axis and the Y-axis. The stage 106 is contrived such that a substrate 11 having cells 14 into which color filter ink 2 will be discharged can be fixed to or held on the flat surface of the stage 106.

The droplet discharge means 103 is moved along the X-axis direction by the first position control device 104, as explained previously. Similarly, the stage 106 is moved along the Y-axis direction by the second position control device 108. Thus, the relative positions of the droplet discharge heads 114 with respect to the stage 106 are changed (i.e., the substrate 11 held on the stage 106 and the droplet discharge means 103 are moved relative to each other) by the first position control device 104 and the second position control device 108.

The controller 112 receives discharge data indicating a relative position where the color filter ink 2 should be discharged from an external information processor.

As shown in FIG. 4, the droplet discharge means 103 has a plurality of droplet discharge heads (inkjet heads) 114, each having the same structure and a carriage 105 contrived to hold the droplet discharge heads 114. In this embodiment, the number of droplet discharge heads 114 held in the droplet discharge means 103 is eight. Each of the droplet discharge heads 114 has a bottom surface on which a plurality of nozzles 118 (described later) is disposed. The shape of the bottom surface of each of the droplet discharge heads 114 is a polygon having two short sides and two long sides. The bottom surface of the droplet discharge heads 114 held in the droplet discharge means 103 faces toward the stage 106, and the long-side direction and the short-side direction of the droplet discharge heads 114 are parallel to the X-axis direction and the Y-axis direction, respectively.

As shown in FIG. 5, the droplet discharge heads 114 have a plurality of nozzles 118 aligned in the X-axis direction. The nozzles 118 are arranged so as to have a prescribed nozzle pitch HXP in the X-axis direction of the droplet discharge heads 114. There are no particular limitations on the specific value of the nozzle pitch HXP and the nozzle pitch HXP can be set to, for example, a value from 50 to 90 μm. In this embodiment, “the nozzle pitch HXP in the X-axis direction of the droplet discharge heads 114” corresponds to the pitch that would result between a plurality of nozzle images obtained by projecting all of the nozzles 118 of the droplet discharge heads 114 onto the X axis along the Y-axis direction.

In this embodiment, the nozzles 118 in the droplet discharge heads 114 form a nozzle row 116A and a nozzle row 116B, both of which extend in the X-axis direction. The nozzle row 116A and the nozzle row 116B are arranged to be parallel to each other with an interval in-between. In the present embodiment, each of the nozzle rows 116A and 116B has 90 nozzles 118 that are aligned in the X-axis direction so as to be separated by a fixed interval LNP. Although there are no particular limitations on the specific value of LNP, LNP can be a value from 100 to 180 μm, for example.

The position of the nozzle row 116B is offset from the position of the nozzle row 116A by half the length of the nozzle pitch LNP in the positive direction of the X-axis (rightward in FIG. 5). For this reason, the nozzle pitch HXP in the X-axis direction of the droplet discharge heads 114 is half the length of the nozzle pitch LNP of the nozzle row 116A (or the nozzle row 116B).

Therefore, the nozzle line density in the X-axis direction of the droplet discharge heads 114 is twice the nozzle line density of the nozzle row 116A (or the nozzle row 116B). In the present specification, “the nozzle line density in the X-axis direction” corresponds to the number per unit length of the plurality of nozzle images obtained by projecting a plurality of nozzles onto the X-axis along the Y-axis direction. Naturally, the number of nozzle rows included in the droplet discharge heads 114 is not limited to two rows. The droplet discharge heads 114 may include a number M of nozzle rows, where M is a natural number equal to or larger than 1. In this case, the plurality of nozzles 118 in each of the M number of nozzle rows is aligned at a pitch having a length that is M times that of the nozzle pitch HXP. If M is a natural number equal to or larger than 2, then, among the M nozzle rows, (M−1) of the nozzle rows are offset from one of the nozzle rows by a distance equal to i times the nozzle pitch HXP in the X-axis direction without overlapping, where i is a natural number from 1 to (M−1).

In the present embodiment, since the nozzle row 116A and the nozzle row 116B are each composed of 90 nozzles 118, a single droplet discharge head 114 has 180 nozzles 118. However, five nozzles at each end of the nozzle row 116A are set as “reserve nozzles.” Similarly, five nozzles at each end of the nozzle row 116B are set as “reserve nozzles.” The color filter ink 2 is not discharged from these twenty “reserve nozzles.” Thus, of the 180 nozzles 118 provided in each of the droplet discharge heads 114, 160 nozzles 118 function as nozzles for discharging the color filter ink 2.

As shown in FIG. 4, in the droplet discharge means 103, the plurality of droplet discharge heads 114 is disposed in two rows along the X-axis direction. The two rows of droplet discharge heads 114 are arranged to partially overlap each other when viewed from the Y-axis direction, the degree of overlap being determined in consideration of the reserve nozzles. As a result, the nozzles 118 for discharging the color filter ink 2 are arranged in the droplet discharge means 103 so as to span uninterruptedly across the X-direction dimension of the substrate 11 in the X-axis direction at the nozzle pitch HXP.

In the droplet discharge means 103 of the present embodiment, the droplet discharge heads 114 are disposed so as to cover the entire length of the X-direction dimension of the substrate 11. However, it is also acceptable for a droplet discharge means in accordance with the present invention to cover a portion of the X-direction dimension of the substrate 11.

Each of the droplet discharge heads 114 is an inkjet head, as shown in the figures. More specifically, each of the droplet discharge heads 114 comprises a vibration plate 126 and a nozzle plate 128. A fluid reservoir 129 is positioned between the vibration plate 126 and the nozzle plate 128. The color filter ink 2 is fed from the tank 101 into the fluid reservoir 129 via a hole 131 such that the fluid reservoir 129 is constantly filled.

A plurality of partition walls 122 are also provided between the vibration plate 126 and the nozzle plate 128, and cavities 120 are formed by the spaces enclosed by the vibration plate 126, the nozzle plate 128, and pairs of partition walls 122. Since the cavities 120 are disposed in correspondence with the nozzles 118, the number of cavities 120 and the number of nozzles 118 are the same. The color filter ink 2 is fed to the cavities 120 from the fluid reservoir 129 via supply ports 130 positioned between pairs of partition walls 122.

An oscillator 124 is arranged on the vibration plate 126 with respect to each of the cavities 120. Each of the oscillators 124 includes a piezoelectric element 124C and a pair of electrodes 124A and 124B that sandwich the piezoelectric element 124C. The color filter ink 2 is discharged from a nozzle 118 by applying a drive voltage between the corresponding pair of electrodes 124A, 124B. The shape of the nozzles 118 is adjusted so that the color filter ink 2 is discharged in the Z-axis direction from the nozzles 118.

The controller 112 (see FIG. 3) may be configured so as to apply signals independently to each of the oscillators 124. In other words, the volume of the color filter ink 2 discharged from each of the nozzles 118 can be controlled independently in accordance with a signal from the controller 112. The controller 112 can also set which nozzles 118 will perform a discharge operation during a coating scan, as well as which nozzles 118 will not perform a discharge operation.

In the present specification, a portion that includes a single nozzle 118, a cavity 120 that corresponds to the nozzle 118, and the oscillator 124 that corresponds to the cavity 120 will be referred to as a “discharge portion 127.” In accordance with this designation, a single droplet discharge head 114 has the same number of discharge portions 127 as the number of nozzles 118.

Using a droplet discharge device 100 like that described above, color filter inks 2 corresponding to the plurality of colored portions 12 of the color filter 1 are deposited into the cells 14. By using such a device, the color filter inks 2 can be selectively deposited into the cells 14 with good efficiency. As described above, a color filter ink 2 has excellent discharge stability and flight deflection, loss of stability in the droplet discharge quantity, and other problems are much less likely to occur, even when droplet discharge is carried out over a long period of time. Therefore, it is possible to reliably prevent such problems as mixing (color mixing) of a plurality of types of ink used in the formation of colored portions having different colors, and variability in the color saturation between the plurality of colored portions in which the same color saturation is required. In the configuration shown in the diagrams, the droplet discharge device 100 has a tank 101 for holding the color filter ink 2, a tube 110, and other components for only one color, but analogous components for a plurality of colors may be provided to accommodate a plurality of different-colored colored portions 12 of a color filter 1. In the manufacture of a color filter 1, it is also acceptable to use a plurality of droplet discharge devices 100 each corresponding to a different color of color filter ink 2.

In the present invention, the droplet discharge heads 114 may use an electrostatic actuator instead of a piezoelectric element as a drive element. It is also acceptable if the droplet discharge heads 114 are contrived to use an electrothermal converter as a drive element and to discharge the color filter ink by utilizing a thermoexpansion of material produced by the electrothermal converter.

### Colored Portion Formation Step

### Curing Step

Next, the solvent (dispersion medium) is removed from the color filter ink 2 in the cells 14 and solid colored portions 12 are formed by curing the curable resin (1e). The color filter 1 is obtained in this manner.

Although heating is ordinarily carried out in this step, it is also acceptable to, for example, execute a treatment involving irradiation of active energy rays or a treatment in which the substrate 11 onto which the color filter ink 2 has been applied is placed under a reduced-pressure environment. By irradiating with active energy rays, the curing reaction of the curable resin can be made to proceed with good efficiency and the curing reaction of the curable resin can be reliably promoted even when the heating temperature is relatively low. Also, the occurrence of adverse effects on the substrate 11 and other components can be reliably prevented. Examples of the active energy rays that may be used include light rays of various wavelengths, UV rays, X-rays, g-rays, i-rays, and excimer lasers. By placing the substrate 11 on which the color filter ink 2 has been applied under a reduced-pressure environment, the solvent (dispersion medium) can be removed with good efficiency, the shape of the colored portions in the pixels (cells) can be reliably made into desirable shapes, the solvent (dispersion medium) can be reliably removed even when the heating temperature is relatively low, and the occurrence of adverse effects on the substrate 11 and the like can be reliably prevented.

Although there are no particular limitations on the heating temperature in this step, a heating temperature 50 to 260° C. is preferred and a heating temperature of 80 to 240° C. is even more preferred.

### Image Display Device

Preferred embodiments of a liquid crystal display device exemplifying an image display device (electro-optic device) having the color filter 1 will now be explained.

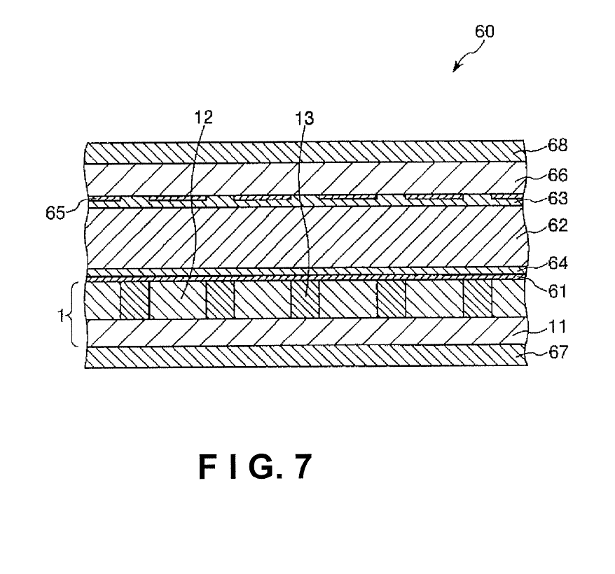

FIG. 7 is a cross-sectional view showing a preferred embodiment of the liquid crystal display device. As shown in the diagram, the liquid crystal display device 60 has a color filter 1, a substrate (opposing substrate) 66 arranged on the surface on which the colored portions 12 of the color filter 1 are disposed, a liquid crystal layer 62 composed of a liquid crystal sealed in the gaps between the color filter 1 and the substrate 66, a polarizing plate 67 disposed on the surface (lower side in FIG. 7) opposite from the surface that faces the liquid crystal layer 62 of the substrate 11 of the color filter 1, and a polarizing plate 68 disposed on the side (upper side in FIG. 7) opposite from the surface that faces liquid crystal layer 62 of the substrate 66. A shared electrode 61 is disposed on the surface of the color filter 1 on which the colored portions 12 and the partition wall 13 are disposed (i.e., the surfaces of the colored portions 12 and the partition walls 13 that are opposite from the surfaces of the same that face the substrate 11). Pixel electrodes 65 are arranged in the form of a matrix on the substrate (opposing substrate) 66 in positions corresponding to the colored portions 12 of the color filter 1. The pixel electrodes 65 are arranged on the side of the substrate 66 that faces the liquid crystal layer 62 and color filter 1. An alignment film 64 is disposed between the shared electrode 61 and the liquid crystal layer 62, and an alignment film 63 is disposed between the substrate 66 (pixel electrodes 65) and the liquid crystal layer 62.

The substrate 66 is a substrate having optical transparency with respect to visible light and is, for example, a glass substrate.

The shared electrode 61 and the pixel electrodes 65 are composed of a material having optical transparency with respect to visible light and are made of, for example, ITO.

Although not depicted in the drawings, a plurality of switching elements (e.g., TFT: thin film transistors) is provided so as to correspond to the pixel electrodes 65. The pixel electrode 65 corresponding to each of the colored portions 12 can be used to control the transmission properties of light in an area corresponding to the colored portion 12 (pixel electrode 65) by controlling the state of a voltage applied between the shared electrode 61 the pixel electrode 65.

In the liquid crystal display device 60, light emitted from a backlight (not depicted in the figures) is incident from the polarizing plate 68 side (the upper side in FIG. 7). The light that passes through the liquid crystal layer 62 and enters the colored portions 12 (12A, 12B, 12C) of the color filter 1 is emitted from the polarizing plate 67 (lower side of FIG. 7) as light having colors that correspond to the respective colored portions 12 (12A, 12B, 12C).

As described above, the colored portions 12 are formed using a color filter ink 2 according to the present invention and therefore have reduced variability in the characteristics between colors and between pixels. As a result, an image having reduced unevenness of color and saturation can be displayed on the liquid crystal display device 60 in a stable fashion. Additionally, an image with excellent contrast can be obtained because the colored portions 12 are formed using a color filter ink that is in accordance with the present invention.

### Electronic Device

A liquid crystal display device or another image display device (electro-optic device) 1000 having a color filter 1 such as that described above can be used in a display unit of a variety of electronic devices.

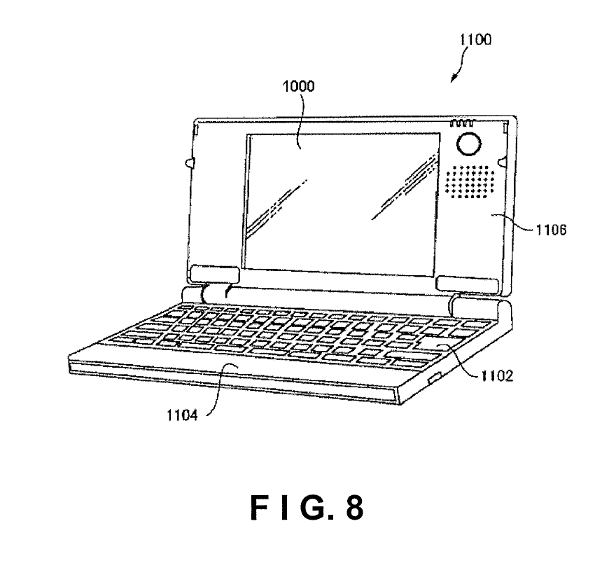

FIG. 8 is a perspective view showing a mobile (or notebook) personal computer exemplifying an electronic device in accordance with the present invention.

As shown in the figure, the personal computer 1100 is comprises a main unit 1104 provided with a keyboard 1102, and a display unit 1106. The display unit 1106 is rotatably supported with respect to the main unit 1104 with a hinge structure.

In the personal computer 1100, the display unit 1106 is provided with an image display device 1000.

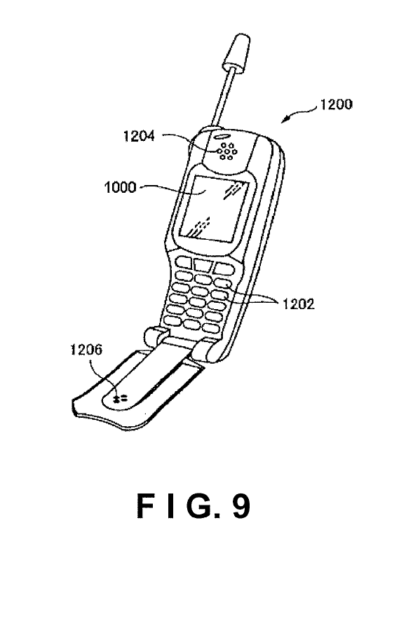

FIG. 9 is a perspective view showing a portable telephone (including PHS) exemplifying an electronic device in accordance with the present invention.

As shown in the figure, the portable telephone 1200 has a plurality of operating buttons 1202, an earpiece 1204, a mouthpiece 1206, and an image display device 1000 provided as a display unit.

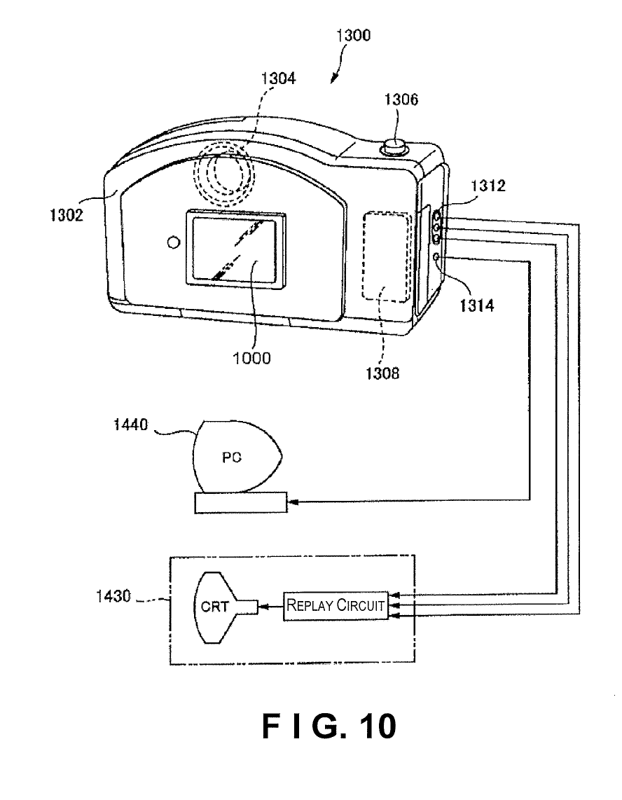

FIG. 10 is a perspective view showing the configuration of a digital still camera exemplifying an electronic device in accordance with the present invention. In the figure, connections to external devices are shown in a simplified manner.

While an ordinary camera exposes a silver-salt photography film to the optical image of a object being photographed, a digital still camera 1300 photoelectrically converts the optical image of an object to be photographed and generates an imaging signal (image signal) with the aid of a CCD (Charge Coupled Device) or another imaging element. An image display device 1000 is disposed in the display section on the back surface of a case (body) 1302 of the digital still camera 1300. The image display device 1000 is contrived to perform display operations based on a pickup signal from the CCD and function as a finder for displaying the object to be photographed as an electronic image.

A circuit board 1308 is disposed inside the case. The circuit board 1308 has a memory that can store (record) the imaging signal. A photo-detection unit 1304 that includes an optical lens (imaging optical system), a CCD, and the like is provided on a front side of the case 1302 (back side from the perspective of the figure). A photographer confirms the image of the object to be photographed displayed on the display unit and depresses a shutter button 1306. When the shutter button 1306 is pressed, the imaging signal of the CCD at that point in time is transferred to and stored in the memory of the circuit board 1308.

A video signal output terminal 1312 and a data communication I/O terminal 1314 are provided on a lateral side face of the case 1302 of the digital still camera 1300. As shown in the figure, a television monitor 1430 is connected to the video signal output terminal 1312 as required, and a personal computer 1440 is connected to the data communication I/O terminal 1314 as required. Additionally, the digital still camera 1300 is contrived to output an imaging signal stored in the memory of the circuit board 1308 to a television monitor 1430 or a personal computer 1440 when a prescribed operation is performed.

In addition to the personal computer (mobile personal computer), portable telephone, and digital still camera described above, other examples of an electronic device in accordance with the present invention include televisions (e.g., liquid crystal display devices), video cameras, view finder-type and direct-view monitor-type video tape recorders, laptop personal computers, car navigation devices, pagers, electronic assistants (including those with a communication function), electronic dictionaries, calculators, electronic game devices, word processors, work stations, videophones, security television monitors, electronic binoculars, POS terminals, apparatuses having a touch panel (e.g., cash dispensers for financial institutions, and automatic ticketing machines), medical equipment (e.g., electronic thermometers, sphygmomanometers, blood glucose sensors, electrocardiograph display devices, ultrasound diagnostic devices, and endoscopic display devices), fish finders, various measuring apparatuses, instruments (e.g., instruments in vehicles, aircraft, and ships), flight simulators, and various other monitors, and projectors, and other projection display devices. Among these, televisions have display units that are tending to become markedly larger in recent years and in electronic devices having such a large display unit (e.g., a display unit having a diagonal length of 80 cm or more), unevenness of color and saturation, and other problems occur particularly readily when a color filter manufactured using a conventional color filter ink is used. However, with the present invention, the occurrence of such problems can be reliably prevented. In other words, the effects of the present invention are exhibited more demonstrably when the invention is applied to an electronic device having a large display unit, such as that described above.

Although the present invention is described heretofore based on preferred embodiments, the present invention is not limited to these embodiments.

For example, in the embodiments described above, color filter inks corresponding to the colored portions of various colors are applied inside the cells and, afterwards, the solvent (dispersed medium) is removed from the different colors of color filter ink in the cells and the curable resin is cured in a single process. In other words, a colored portion formation step (curing step) is carried out only once. However, it is acceptable to repeat the ink application step and the colored portion formation step for each color.

It is also possible to replace any of the parts constituting a color filter, an image display device, or electronic device with any other part that demonstrates the same function, or to add other constituent parts. For example, in a color filter according to the present invention, a protective film for covering the colored portions may be provided on the surface of the colored portions that is opposite from the surface facing the substrate. Damage, degradation, and the like of the colored portions can thereby be more effectively prevented.

Although the embodiments presented above describe chiefly a case in which a color filter ink set is provided with three types (three colors) of color filter inks corresponding to the three primary colors of light was mainly described, the number and type (color) of color filter inks constituting the ink set for a color filter is not limited to the arrangement described above. For example, in the present invention, the ink set for a color filter may be one provided with four or more types of color filter inks.

### EXAMPLES

### Specific Working Examples of the Present Invention Will Now be Described

### 1. Preparation of Color Filter Inks

### Example 1

25.01 g (69 parts by weight) of the dispersing agent Disperbyk 162, 8.33 g (23 parts by weight) of the dispersing agent Disperbyk 111, 19.53 g (54 parts by weight) of the thermoplastic resin SPCN-17× (manufactured by Showa Highpolymer Co., limited), and 91.14 g (253 parts by weight) of the solvent 1,3-butylene glycol diacetate were put into an agitating machine (single-axis mixer) having a capacity of 400 cc and agitated for 10 minutes with a dispermill as a preparatory dispersion treatment, thereby obtaining a dispersing-agent-dispersed liquid (preparatory dispersion step). The rotational speed of the agitation propeller of the agitating machine was 2000 rpm.

A fine dispersion step was then executed by adding pigments to the dispersing-agent-dispersed liquid obtained in the preparatory dispersion step and adding inorganic beads in multiple stages as a fine dispersion treatment.

First, 35.99 g (100 parts by weight) of a pigment were added to the dispersing-agent-dispersed liquid and agitated for 10 minutes. The rotational speed of the agitation propeller of the agitating machine was 2000 rpm. The pigment used was a mixture of 17.99 g of a powder comprising chiefly C.I. pigment red 177 and having a pigment derivative expressed by Formula (I) below near a surface thereof and 18.00 g of a powder comprising chiefly C.I. pigment red 254 and having a pigment derivative expressed by Formula (II) below near a surface thereof. Meanwhile, the mixture of the dispersing-agent-dispersed liquid and the pigment was diluted with the solvent 1,3-butylene glycol diacetate such that the content of pigment in the mixture would be 16 wt %.

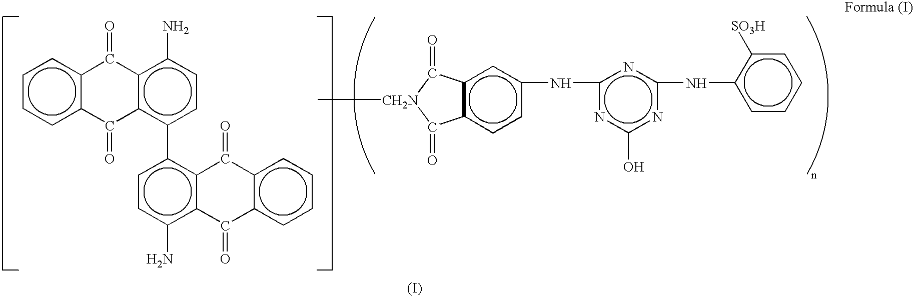

In Formula (I), n is an integer from 1 to 4.

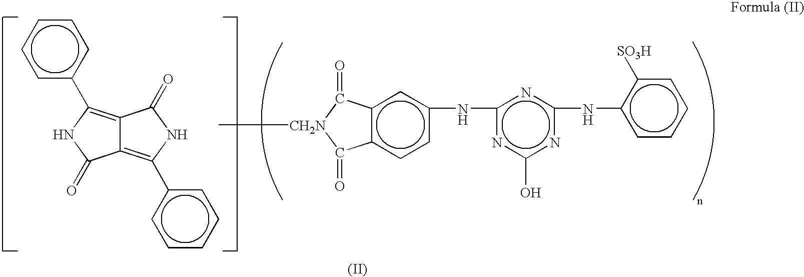

In Formula (II), n is an integer from 1 to 4.

Next, 720 g of inorganic beads (first inorganic beads made of zirconia (Torayceram (trade name) pulverizing balls manufactured by Toray Industries)) having an average particle diameter 0.8 mm were added and a first-stage dispersion treatment (first treatment) was executed by agitating the mixture for 30 minutes at room temperature. The rotational speed of the agitation propeller of the agitating machine was 2000 rpm.

The inorganic beads (first inorganic beads) were then removed by filtering with a filter (Pall HDC II Membrane Filter manufactured by Pall Corporation), 720 g of inorganic beads (second inorganic beads made of zirconia (Torayceram (trade name) pulverizing balls manufactured by Toray Industries)) having an average particle diameter of 0.1 mm were added, and a second-stage dispersion treatment (second treatment) was executed by agitating the mixture for another 30 minutes. The rotational speed of the agitation propeller of the agitating machine was 2000 rpm. Meanwhile, the resulting mixture was diluted with the solvent 1,3-butylene glycol diacetate such that the content of pigment in the pigment dispersed material would be 13 wt %.

The inorganic beads (second inorganic beads) were then removed to by filtering with a filter (Pall HDC II Membrane Filter manufactured by Pall Corporation), thereby obtaining a pigment dispersed material.

Meanwhile, a resin a1 used as a curable resin was synthesized as follows.

320 parts by weight of n-hexane, 86 parts by weight of methacrylate, and 111 parts by weight of triethylamine were put into a four-neck flask and a thermometer, a reflux condenser, an agitator, and a nitrogen gas inlet were mounted to the four-neck flask. Then, 120 parts by weight of trimethyl chlorosilane were dropped into the four-necked flask while cooling the four-necked flask with ice. The temperature inside the reaction system was kept at 25° C. or below. The reaction was continued for one hour at 25° C. Then, the triethylamine hydrochloride was filtered out and the n-hexane was removed from the remaining filtrate under low pressure conditions. The filtrate was then refined by low-pressure distillation to obtain an ethylenically unsaturated monomer having a silyl acetate structure.

Next, a four-necked flask containing 100 parts by weight of 1,3-butylene glycol diacetate as a solvent and fitted with a thermometer, a reflux condenser, an agitator, and a nitrogen gas inlet was prepared. The 1,3-butylene glycol acetate inside the four-necked flask was agitated while being warmed to 60° C., and afterwards a mixture of 27 parts by weight of the aforementioned ethylenically unsaturated monomer, 30 parts by weight of glycerol methacrylate, 38 parts by weight of styrene, and 6 parts by weight of 2,2′-azobis-(2,4-dimethyl valeronitrile) was dropped into the flask for one hour. After dropping, the mixture was held for one hour at 60° C., after which 0.08 parts by weight of 2,2′-azobis-(2,4-dimethyl valeronitrile) was added and the mixture was allowed to react for another six hours at 60° C. Then, unreacted monomers were removed using a reduced pressure treatment and a solution of the resin a1 (epoxy resin having a silyl acetate structure and an epoxy structure) was obtained.

Next, the pigment dispersed material obtained as described above was mixed with the solution of the resin a1 (curable resin). In this step, the pigment dispersed material and the solution of the polymer a1 are put into an agitating machine (single-axis mixer) having a capacity of 400 cc and agitated for 20 minutes with a dispermill. The rotational speed of the agitation propeller of the agitating machine was 1500 rpm. In this way, a red color filter ink (red ink) in accordance with the present invention was obtained.

A green color filter ink (G ink) and a blue color filter ink (B ink) were prepared in the same manner as the red color filter ink described above, except that the type of pigment and the usage amount of each component were varied. Accordingly, an ink set composed of the three colors red, green, and blue were obtained. The average particle diameters of the pigment used in the red ink, the pigment used in the green ink, and the pigment used in the green ink were 70 nm, 70 nm, and 70 nm, respectively.

### Examples 2 to 6

The color filter inks were prepared in substantially the same manner as in Working Example 1 except that the types and amounts of materials used to prepare the color filter ink were changed and the treatment conditions used in the fine dispersion step (first treatment and second treatment) and the curable resin mixing step were modified as indicated in Tables 1, 2, 3, and 4.

### Comparative Example 1

The color filter inks were prepared in substantially the same manner as in Working Example 1 except that the preparatory dispersion step was omitted.

### Comparative Example 2

The color filter inks were prepared in substantially the same manner as in Working Example 1 except that the treatment time of the first stage of the dispersion treatment (first treatment) was 60 minutes and the second stage of the dispersion treatment (second treatment) was omitted.

### Comparative Example 3

The color filter inks were prepared in substantially the same manner as in Working Example 1 except that the first stage of the dispersion treatment (first treatment) was omitted and the treatment time of the second stage of the dispersion treatment (first treatment) was 60 minutes.

### Comparative Example 4

As shown in Table 2, the color filter inks were prepared in substantially the same manner as in Comparative Example 3 except that the amounts of the components used were different.

The composition of the dispersing-agent-dispersed liquid, the types and amounts of the pigments added to the dispersing-agent-dispersed liquid in the fine dispersing step, and the types and solid amounts of curable resin used in the curable resin mixing step are summarized in Tables 1 and 2 for each of the working examples and comparative examples. In the Tables 1 and 2, “PR177” indicates C.I. pigment red 177; “PR254” indicates C.I. pigment red 254; “PG36” indicates C.I. pigment green 36; “PG58” indicates C.I. pigment green 58; “PB15:6” indicates C.I. pigment blue 15:6; “PR177D” indicates a powder comprising chiefly C.I. pigment red 177 and having a powder comprising a pigment derivative expressed by the aforementioned Formula (I) near a surface thereof; “PR254D” a powder comprising chiefly C.I. pigment red 254 and having a powder comprising a pigment derivative expressed by the aforementioned Formula (II) near a surface thereof; “PYD” indicates a powder comprising a pigment derivative expressed by Formula (III) shown below; “S I” indicates 1,3-butylene glycol diacetate; “S2” indicates diethylene glycol dibutyl ether; “S3” indicates diethylene glycol monobutyl ether acetate; “S4” indicates tripropylene glycol monomethyl ether; “DA1” indicates Disperbyk 162; “DA2” indicates Disperbyk 163; “DA3” indicates EFKA 4300; “DA4” indicates Disperbyk 111; and “DR1” indicates SPCN-17×. In Tables 1 and 2, the acid value or amine value (acid values and amine values calculated based on solid components) of each dispersing agent and the viscosity of the color filter ink are also shown. The acid values shown were found using a method in compliance with DINENISO2114 and the amine values shown were found using a method in compliance with DINENISO16945. The manufacturing conditions for manufacturing the color filter inks in the working examples and comparative examples are summarized in Tables 3 and 4. The contents (weight percents) of pigment at the end of the first treatment, the end of the second treatment, and the end of the curable resin mixing step (finished color filter ink) are also shown in Tables 3 and 4. Viscosity measurements were conducted in accordance with JIS Z8809 using an E-type viscometer (RE-01 manufactured by Toki Sangyo Co., Ltd.) in an environment at 25° C.

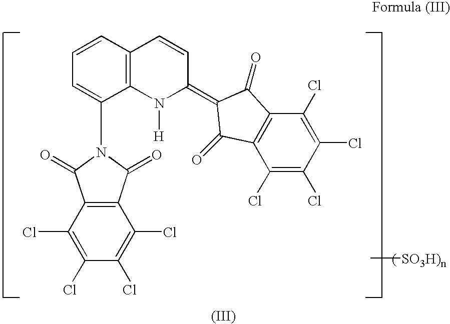

In Formula (III), n is an integer from 1 to 5.

TABLE 1

| | | COMPOSITION OF DISPERSING-AGENT-DISPERSED LIQUID | | | | | | | | | |
|---|---|---|---|---|---|---|---|---|---|---|---|
| | | DISPERSING AGENT | | | | | | | | | |
| | | AMINE DISPERSING | | | | | | THERMO- | | | |
| | | AGENT | | | ACID DISPERSING AGENT | | | PLASTIC | | | |
| | | | AMINE | | | ACID | | RESIN | | SOLVENT | |
| | | | VALUE | AMOUNT | | VALUE | AMOUNT | | AMOUNT | | AMOUNT |
| | | | (KOH | (PARTS | | (KOH | (PARTS | | (PARTS | | (PARTS |
| | | TYPE | mg/g) | BY WT.) | TYPE | mg/g) | BY WT.) | TYPE | BY WT.) | TYPE | BY WT.) |
| EXAMPLE 1 | R INK | DA1 | 34 | 69 | DA4 | 129 | 23 | DR1 | 54 | S1 | 253 |
| | G INK | DA1 | 34 | 36 | DA4 | 129 | 12 | DR1 | 79 | S1 | 172 |
| | B INK | DA1 | 34 | 42 | DA4 | 129 | 14 | DR1 | 88 | S2 | 312 |
| EXAMPLE 2 | R INK | DA1 | 34 | 54 | DA4 | 129 | 18 | DR1 | 40 | S2 | 287 |
| | G INK | DA1 | 34 | 68 | DA4 | 129 | 22 | DR1 | 30 | S3 | 179 |
| | B INK | DA1 | 34 | 42 | DA4 | 129 | 14 | DR1 | 88 | S1 | 312 |
| EXAMPLE 3 | R INK | DA2 | 22 | 99 | — | — | — | DR1 | 28 | S1 | 272 |
| | G INK | DA2 | 22 | 50 | — | — | — | DR1 | 21 | S4 | 228 |
| | B INK | DA2 | 22 | 127 | — | — | — | DR1 | 32 | S4 | 297 |
| EXAMPLE 4 | R INK | DA3 | 70 | 40 | — | — | — | DR1 | 82 | S4 | 277 |
| | G INK | DA1 | 34 | 27 | — | — | — | DR1 | 41 | S4 | 231 |
| | B INK | DA1 | 34 | 50 | — | — | — | DR1 | 92 | S4 | 314 |
| EXAMPLE 5 | R INK | — | — | — | DA4 | 129 | 60 | DR1 | 112 | S1 | 227 |
| | G INK | — | — | — | DA4 | 129 | 42 | DR1 | 84 | S1 | 173 |
| | B INK | — | — | — | DA4 | 129 | 63 | DR1 | 123 | S1 | 270 |

| | | | | | | COMPONENTS | | |
|---|---|---|---|---|---|---|---|---|
| | | | | | | ADDED IN | | |
| | | COMPONENTS ADDED IN FINE | | | | CURABLE RESIN | | |
| | | DISPERSION STEP | | | | MIXING STEP | | |
| | | PIGMENT | | PIGMENT | | CURABLE RESIN | | |
| | | | AMOUNT | | AMOUNT | | AMOUNT | VISCOSITY |
| | | | (PARTS | | (PARTS | | (PARTS | OF INK |
| | | TYPE | BY WT.) | TYPE | BY WT.) | TYPE | BY WT.) | (mP-s) |
| EXAMPLE 1 | R INK | PR177D | 50 | PR254D | 50 | a1 | 30 | 10.9 |
| | G INK | PG58 | 90 | PYD | 10 | a1 | 20 | 8.9 |
| | B INK | PB15:6 | 100 | — | — | a1 | 42 | 8.7 |
| EXAMPLE 2 | R INK | PR177D | 100 | — | — | a1 | 38 | 10.9 |
| | G INK | PG58 | 85 | PYD | 15 | a1 | 37 | 9.1 |
| | B INK | PB15:6 | 100 | — | — | a1 | 36 | 9.2 |
| EXAMPLE 3 | R INK | PR177 | 50 | PR254 | 50 | a1 | 55 | 10.8 |
| | G INK | PG58 | 100 | — | — | a1 | 52 | 9.2 |
| | B INK | PB15:6 | 100 | — | — | a1 | 51 | 8.7 |
| EXAMPLE 4 | R INK | PR177 | 100 | — | — | a1 | 33 | 11.0 |
| | G INK | PG58 | 100 | — | — | a1 | 35 | 10.1 |
| | B INK | PB15:6 | 100 | — | — | a1 | 31 | 9.1 |
| EXAMPLE 5 | R INK | PR254 | 100 | — | — | a1 | 14 | 10.4 |
| | G INK | PG58 | 100 | — | — | a1 | 14 | 9.1 |
| | B INK | PB15:6 | 100 | — | — | a1 | 14 | 87 |

TABLE 2

| | | COMPOSITION OF DISPERSING-AGENT-DISPERSED LIQUID | | | | | | | | | |
|---|---|---|---|---|---|---|---|---|---|---|---|
| | | DISPERSING AGENT | | | | | | THERMO- | | | |
| | | AMINE DISPERSING | | | ACID DISPERSING | | | PLASTIC | | | |
| | | AGENT | | | AGENT | | | RESIN | | SOLVENT | |
| | | | AMINE | AMOUNT | | ACID | AMOUNT | | AMOUNT | | AMOUNT |
| | | | VALUE | (PARTS BY | | VALUE | (PARTS BY | | (PARTS BY | | (PARTS |
| | | TYPE | (KOH mg/g) | WT.) | TYPE | (KOH mg/g) | WT.) | TYPE | WT.) | TYPE | BY WT.) |
| EXAMPLE 6 | R INK | DA3 | 70 | 23 | DA4 | 129 | 69 | DR1 | 54 | S2 | 253 |
| | G INK | DA3 | 70 | 12 | DA4 | 129 | 36 | DR1 | 79 | S2 | 172 |
| | B INK | DA3 | 70 | 14 | DA4 | 129 | 42 | DR1 | 88 | S2 | 312 |
| COMPARATIVE | R INK | DA1 | 34 | 69 | DA4 | 129 | 23 | DR1 | 54 | S1 | 224 |
| EXAMPLE 1 | G INK | DA1 | 34 | 36 | DA4 | 129 | 12 | DR1 | 79 | S1 | 172 |
| | B INK | DA1 | 34 | 42 | DA4 | 129 | 14 | DR1 | 88 | S2 | 312 |
| COMPARATIVE | R INK | DA1 | 34 | 69 | DA4 | 129 | 23 | DR1 | 54 | S1 | 224 |
| EXAMPLE 2 | G INK | DA1 | 34 | 36 | DA4 | 129 | 12 | DR1 | 79 | S1 | 172 |
| | B INK | DA1 | 34 | 42 | DA4 | 129 | 14 | DR1 | 88 | S2 | 312 |
| COMPARATIVE | R INK | DA1 | 34 | 69 | DA4 | 129 | 23 | DR1 | 54 | S1 | 224 |
| EXAMPLE 3 | G INK | DA1 | 34 | 36 | DA4 | 129 | 12 | DR1 | 79 | S1 | 172 |
| | B INK | DA1 | 34 | 42 | DA4 | 129 | 14 | DR1 | 88 | S2 | 312 |
| COMPARATIVE | R INK | DA1 | 34 | 132 | — | — | — | DR1 | 30 | S1 | 237 |
| EXAMPLE 4 | G INK | — | — | — | DA4 | 129 | 100 | DR1 | 35 | S1 | 164 |
| | B INK | — | — | — | DA4 | 129 | 150 | DR1 | 42 | S2 | 264 |

| | | | | | | COMPONENTS | | |
|---|---|---|---|---|---|---|---|---|
| | | | | | | ADDED IN | | |
| | | COMPONENTS ADDED IN FINE | | | | CURABLE RESIN | | |
| | | DISPERSION STEP | | | | MIXING STEP | | |
| | | PIGMENT | | PIGMENT | | CURABLE RESIN | | |
| | | | AMOUNT | | AMOUNT | | AMOUNT | VISCOSITY |
| | | | (PARTS | | (PARTS | | (PARTS | OF INK |
| | | TYPE | BY WT.) | TYPE | BY WT.) | TYPE | BY WT.) | (mP-s) |
| EXAMPLE 6 | R INK | PR254 | 100 | — | — | a1 | 32 | 10.6 |
| | G INK | PG58 | 100 | — | — | a1 | 21 | 9.4 |
| | B INK | PB15:6 | 100 | — | — | a1 | 41 | 8.9 |
| COMPARATIVE | R INK | PR177D | 50 | PR254D | 50 | a1 | 30 | 11.0 |
| EXAMPLE 1 | G INK | PG58 | 90 | PYD | 10 | a1 | 20 | 9.6 |
| | B INK | PB15:6 | 100 | — | — | a1 | 42 | 8.9 |
| COMPARATIVE | R INK | PR177D | 50 | PR254D | 50 | a1 | 30 | 10.7 |
| EXAMPLE 2 | G INK | PG58 | 90 | PYD | 10 | a1 | 20 | 7.9 |
| | B INK | PB15:6 | 100 | — | — | a1 | 42 | 8.9 |
| COMPARATIVE | R INK | PR177D | 50 | PR254D | 50 | a1 | 30 | 10.9 |
| EXAMPLE 3 | G INK | PG58 | 90 | PYD | 10 | a1 | 20 | 7.8 |
| | B INK | PB15:6 | 100 | — | — | a1 | 42 | 8.1 |
| COMPARATIVE | R INK | PR177D | 50 | PR254D | 50 | a1 | 30 | 9.9 |
| EXAMPLE 4 | G INK | PG58 | 90 | PYD | 10 | a1 | 20 | 10.1 |
| | B INK | PB15:6 | 100 | — | — | a1 | 42 | 10.1 |

TABLE 3

| | | | | FINE DISPERSION STEP | | | | |
|---|---|---|---|---|---|---|---|---|
| | | | | FIRST TREATMENT | | | | |
| | | | | FIRST INORGANIC BEADS | | | | |
| | | | | | AMOUNT | | | |
| | | | | | (PART BY | | | |
| | | | | | wt.) PER 100 | | | |
| | | | | | PARTS BY | | | |
| | | PREPARATORY | | | WEIGHT OF | | | |
| | | DISPERSION STEP | | AVERAGE | DISPERSING- | TREAT- | | |
| | | TREATMENT | | PARTCILE | AGENT- | MENT | | PIGMENT |
| | | TIME | ROTATIONAL | DIAMETER | DISPERSED | TIME | ROTATIONAL | CONTENT |
| | | (min.) | SPEED (rpm) | (mm) | LIQUID | (min.) | SPEED (rpm) | (wt %) |
| EXAMPLE 1 | R INK | 10 | 2000 | 0.8 | 500 | 30 | 2000 | 16 |
| | G INK | 3 | 2500 | 1.0 | 350 | 35 | 1700 | 17 |
| | B INK | 7 | 1800 | 0.8 | 500 | 30 | 2000 | 12 |
| EXAMPLE 2 | R INK | 15 | 1200 | 0.6 | 300 | 20 | 2500 | 17 |
| | G INK | 5 | 2000 | 0.7 | 450 | 25 | 1900 | 17 |
| | B INK | 6 | 1900 | 0.8 | 550 | 25 | 2300 | 14 |
| EXAMPLE 3 | R INK | 2 | 4200 | 1.3 | 550 | 60 | 4000 | 16 |
| | G INK | 2 | 4100 | 1.4 | 500 | 70 | 4200 | 15 |
| | B INK | 2 | 4000 | 1.3 | 550 | 70 | 4000 | 10 |
| EXAMPLE 4 | R INK | 25 | 2200 | 0.7 | 500 | 10 | 2000 | 16 |
| | G INK | 30 | 2400 | 1.1 | 350 | 12 | 1700 | 13 |
| | B INK | 25 | 2000 | 0.6 | 500 | 10 | 2000 | 15 |
| EXAMPLE 5 | R INK | 8 | 2000 | 0.4 | 500 | 40 | 2000 | 17 |
| | G INK | 10 | 2500 | 0.4 | 350 | 40 | 1700 | 15 |
| | B INK | 7 | 1800 | 0.4 | 500 | 40 | 2000 | 10 |

| | | FINE DISPERSION STEP | | | | | | | |
|---|---|---|---|---|---|---|---|---|---|
| | | SECOND TREATMENT | | | | | | | |
| | | SECOND | | | | | | | |
| | | INORGANIC BEADS | | | | | | | |
| | | | AMOUNT | | | | | | |
| | | | (PARTS BY wt.) | | | | CURABLE RESIN | | |
| | | | PER 100 PARTS | | | | MIXING STEP | | |
| | | | BY WEIGHT OF | | | | | RO- | |
| | | AVERAGE | DISPERSING- | TREAT- | RO- | | TREAT- | TATION- | |
| | | PARTICLE | AGENT- | MENT | TATIONAL | PIGMENT | MENT | AL | PIGMENT |
| | | DIAMETER | DISPERSED | TIME | SPEED | CONTENT | TIME | SPEED | CONTENT |
| | | (mm) | LIQUID | (min.) | (rpm) | (wt %) | (min.) | (rpm) | (wt %) |
| EXAMPLE 1 | R INK | 0.1 | 500 | 30 | 2000 | 13 | 20 | 1500 | 7.3 |
| | G INK | 0.1 | 450 | 20 | 2500 | 14 | 25 | 2000 | 10.1 |
| | B INK | 0.1 | 500 | 30 | 2000 | 8 | 30 | 1800 | 4.9 |
| EXAMPLE 2 | R INK | 0.07 | 350 | 20 | 3000 | 13 | 40 | 3000 | 7.1 |
| | G INK | 0.2 | 500 | 25 | 2200 | 13 | 45 | 3500 | 9.8 |
| | B INK | 0.1 | 550 | 30 | 1900 | 12 | 35 | 2800 | 4.8 |
| EXAMPLE 3 | R INK | 0.1 | 180 | 50 | 4000 | 14 | 15 | 1400 | 7.3 |
| | G INK | 0.1 | 170 | 45 | 4000 | 13 | 20 | 2100 | 10.1 |
| | B INK | 0.1 | 18 | 50 | 4000 | 8 | 25 | 2000 | 4.9 |
| EXAMPLE 4 | R INK | 0.1 | 500 | 35 | 2300 | 14 | 20 | 1600 | 7.3 |
| | G INK | 0.1 | 450 | 40 | 2700 | 12 | 25 | 1800 | 10.1 |
| | B INK | 0.1 | 500 | 30 | 2200 | 10 | 30 | 1600 | 4.9 |
| EXAMPLE 5 | R INK | 0.07 | 500 | 35 | 2000 | 15 | 20 | 2700 | 7.3 |
| | G INK | 0.05 | 450 | 30 | 2500 | 14 | 25 | 3000 | 10.1 |
| | B INK | 0.1 | 500 | 40 | 2000 | 9 | 30 | 2500 | 4.9 |

TABLE 4

| | | | | FINE DISPERSION STEP | | | | |
|---|---|---|---|---|---|---|---|---|
| | | | | FIRST TREATMENT | | | | |
| | | | | FIRST | | | | |
| | | | | INORGANIC BEADS | | | | |
| | | | | | AMOUNT | | | |
| | | | | | (PARTS BY wt.) | | | |
| | | PREPARATORY | | | PER 100 | | | |
| | | DISPERSION | | | PARTS BY | | | |
| | | STEP | | | WEIGHT OF | | | |
| | | TREAT- | | AVERAGE | DISPERSING- | TREAT- | | |
| | | MENT | | PARTICLE | AGENT- | MENT | ROTATIONAL | PIGMENT |
| | | TIME | ROTATIONAL | DIAMETER | DISPERSED | TIME | SPEED | CONTENT |
| | | (min.) | SPEED (rpm) | (mm) | LIQUID | (min.) | (rpm) | (wt %) |
| EXAMPLE 6 | R INK | 15 | 1000 | 0.4 | 200 | 60 | 1000 | 16 |
| | G INK | 20 | 1200 | 0.4 | 250 | 70 | 1100 | 15 |
| | B INK | 15 | 1000 | 0.4 | 300 | 70 | 1000 | 10 |
| COMPARATIVE | R INK | — | — | 0.8 | 500 | 30 | 2000 | 16 |
| EXAMPLE 1 | G INK | — | — | 1.0 | 350 | 35 | 1700 | 17 |
| | B INK | — | — | 0.8 | 500 | 30 | 2000 | 12 |
| COMPARATIVE | R INK | 10 | 2000 | 0.8 | 500 | 60 | 2000 | 13 |
| EXAMPLE 2 | G INK | 3 | 2500 | 1.0 | 350 | 55 | 1700 | 14 |
| | B INK | 7 | 1800 | 0.8 | 500 | 60 | 2000 | 8 |
| COMPARATIVE | R INK | 10 | 2000 | — | — | — | — | — |
| EXAMPLE 3 | G INK | 3 | 2500 | — | — | — | — | — |
| | B INK | 7 | 1800 | — | — | — | — | — |
| COMPARATIVE | R INK | 10 | 2000 | — | — | — | — | — |
| EXAMPLE 4 | G INK | 3 | 2500 | — | — | — | — | — |
| | B INK | 7 | 1800 | — | — | — | — | — |

| | | FINE DISPERSION STEP | | | | | | | |
|---|---|---|---|---|---|---|---|---|---|
| | | SECOND TREATMENT | | | | | | | |
| | | SECOND | | | | | | | |
| | | INORGANIC BEADS | | | | | | | |
| | | | AMOUNT | | | | | | |
| | | | (PARTS BY wt.) | | | | | | |
| | | | PER 100 | | | | | | |
| | | | PARTS BY | | | | CURABLE | | |
| | | | WEIGT OF | | | | RESIN MIXING STEP | | |
| | | AVERAGE | DISPERSING- | TREAT- | ROTA- | | TREAT- | ROTA- | |
| | | PARTICLE | AGENT- | MENT | TIONAL | PIGMENT | MENT | TIONAL | PIGMENT |
| | | DIAMETER | DISPERSED | TIME | SPEED | CONTENT | TIME | SPEED | CONTENT |
| | | (mm) | LIQUID | (min.) | (rpm) | (wt %) | (min.) | (rpm) | (wt %) |
| EXAMPLE 6 | R INK | 0.1 | 600 | 50 | 2200 | 14 | 15 | 1600 | 7.3 |
| | G INK | 0.1 | 600 | 45 | 2500 | 13 | 20 | 2300 | 10.1 |
| | B INK | 0.1 | 550 | 50 | 2300 | 8 | 25 | 2100 | 4.9 |
| COMPARATIVE | R INK | 0.1 | 500 | 30 | 2000 | 13 | 20 | 1500 | 7.3 |
| EXAMPLE 1 | G INK | 0.1 | 450 | 20 | 2500 | 14 | 25 | 2000 | 10.1 |
| | B INK | 0.1 | 500 | 30 | 2000 | 8 | 30 | 1800 | 4.9 |
| COMPARATIVE | R INK | — | — | — | — | — | 20 | 1500 | 7.3 |
| EXAMPLE 2 | G INK | — | — | — | — | — | 25 | 2000 | 10.1 |
| | B INK | — | — | — | — | — | 30 | 1800 | 4.9 |
| COMPARATIVE | R INK | 0.1 | 500 | 60 | 2000 | 13 | 20 | 1500 | 7.3 |
| EXAMPLE 3 | G INK | 0.1 | 450 | 55 | 2500 | 14 | 25 | 2000 | 10.1 |
| | B INK | 0.1 | 500 | 60 | 2000 | 8 | 30 | 1800 | 4.9 |
| COMPARATIVE | R INK | 0.1 | 500 | 60 | 2000 | 13 | 20 | 1500 | 7.3 |
| EXAMPLE 4 | G INK | 0.1 | 450 | 55 | 2500 | 14 | 25 | 2000 | 10.1 |
| | B INK | 0.1 | 500 | 60 | 2000 | 8 | 30 | 1800 | 4.9 |

### 2. Evaluation of Stability (Durability) of Color Filter Inks

### 2-1. Change in External Appearance after Heat Treatment

The color filter inks of each of the working examples and comparative examples was visually inspected after being held at 60° C. for seven days and evaluated in terms of the four categories shown below.

A: No change observed in comparison with before heating.

B: Slight cohesion and precipitation of pigment particles observed.

C: Obvious cohesion and precipitation of pigment particles observed.

D: Marked cohesion and precipitation of pigment particles observed.

### 2-2. Amount of Change in Viscosity

The viscosities (kinematic viscosity) of the color filter inks of each of the working examples and comparative examples was measured after each color filter ink had been held at 60° C. for seven days and the difference between the viscosity immediately after the color filter ink was manufactured and the viscosity after seven days was calculated. More specifically, a viscosity ν0 (mPa-s) was measured immediately after manufacturing, a viscosity ν1 (mPa-s) was measured after seven days at 60° C., and a difference value ν1-ν0 was calculated. The calculate value was then evaluated in terms of the five categories shown below.

A: The value of ν1-ν0 was smaller than 0.2 mPa-s.

B: The value of ν1-ν0 was equal to or larger than 0.2 mPa-s and smaller than 0.3 mPa-s.

C: The value of ν1-ν0 was equal to or larger than 0.3 mPa-s and smaller than 0.5 mPa-s.

D: The value of ν1-ν0 was equal to or larger than 0.5 mPa-s and smaller than 0.7 mPa-s.

E: The value of ν1-ν0 was equal to or larger than 0.7 mPa-s.

### 3. Evaluation of Stability of Droplet Discharge

### Evaluation of Stable Discharge Properties

The color filter inks obtained in each of the working examples and comparative examples (color filter ink immediately after manufacturing) and color filter inks that had been held at 60° C. for seven days after manufacturing (color filter ink held in a heated environment) were evaluated by being subjected to the tests explained below.

### 3-1. Evaluation of Landing Position Accuracy

A droplet discharge device such as that shown in FIGS. 3 to 6 was disposed in a chamber (thermal chamber), and the ink sets for a color filter of the working examples and comparative examples were prepared. 70,000 droplets (70,000 drops) of the inks were continuously discharged from the nozzles of a droplet discharge head in a state in which the drive waveform of the piezoelectric element had been optimized. The average value of the offset distance d from the center aim position of the center position of the landed droplets was calculated for the 70,000 droplets discharged from specified nozzles in the vicinity of the center of the droplet discharge head, and an evaluation was made based on the four ranges described below. Basically, the smaller this value is, the more effectively flight deflection is being prevented.

A: The average value of an offset distance d is smaller than 0.03 μm.

B: The average value of the offset distance d is equal to or larger than 0.03 μm and smaller than 0.08 μm.

C: The average value of the offset distance d is equal to or larger than 0.08 μm and smaller than 0.12 μm.

D: The average value of the offset distance d is equal to or larger than 0.12 μm.

### 3-2. Evaluation of Stability of Droplet Discharge Quantity

A droplet discharge device such as that shown in FIGS. 3 to 6 was disposed in a chamber (thermal chamber), and the ink sets for a color filter of the working examples and comparative examples were prepared. 70,000 droplets (70,000 drops) of the inks were continuously discharged from the nozzles of a droplet discharge head in a state in which the drive waveform of the piezoelectric element had been optimized. The total weight of the discharged droplets was calculated for two specific nozzles at the left and right ends of the droplet discharge head, and the absolute value ΔW (ng) of the difference between the average discharge quantities of the droplets discharged from the two nozzles was calculated. The ratio (ΔW/W_{T}) of the ΔW in relation to a target discharge quantity W_{T}(ng) of the droplets was calculated, and an evaluation was made based on the four ranges described below. Basically, the smaller the value of ΔW/W_{T} is, the better the stability of the droplet discharge quantity is.

A: The value of ΔW/W_{T} is smaller than 0.020.

B: The value of ΔW/W_{T} is equal to or larger than 0.020 and smaller than 0.420.

C: The value of ΔW/W_{T} is equal to or larger than 0.420 and smaller than 0.720.

D: The value of ΔW/W_{T} is equal to or larger 0.720.

### 3-3. Evaluation of Intermittent Printing Performance

A droplet discharge device such as that shown in FIGS. 3 to 6 was disposed in a chamber (thermal chamber), and the ink sets for a color filter of the examples and comparative examples were prepared. 7000 droplets (7000 drops) of the inks were continuously discharged from the nozzles of a droplet discharge head in a state in which the drive waveform of the piezoelectric element had been optimized, after which droplet discharging was stopped for 30 seconds (first sequence). Thereafter, droplets were continuously discharged in the same manner and the operation of stopping the discharge of droplets was repeated. The average weight W₁ (ng) of the droplets discharged in the first sequence and the average weight W₂₀ (ng) of the droplets discharged in the 20^{th} sequence were calculated for the specified nozzles in the vicinity of the center of the droplet discharge head. The ratio of the absolute value of the difference between W1 and W20 to a target discharge quantity W_{T}, i.e., the ratio (|W1−W20|/W_{T}), was calculated, and an evaluation was made based on the three ranges described below. Basically, the smaller the value of |W1−W20|/W_{T} is, the better the intermittent printing performance (stability of the droplet discharge quantity) is.

A: The value of |W1−W20|/W_{T} is smaller than 0.025.

B: The value of |W1−W20|/W_{T} is equal to or larger than 0.025 and smaller than 0.625.

The value of |W₁−W₂₀|/W_{T} is 0.625 or higher.

### 3-4. Continuous Discharge Test

The inks constituting the ink set for a color filter were discharged by continuously operating the droplet discharge device for 72 hours in an environment of 45% RH using a droplet discharge device such as that shown in FIGS. 3 to 6 disposed in a chamber (thermal chamber); the color filter ink sets of each of the working examples and comparative examples were tested.

The rate ([(number of clogged nozzles)/(total number of nozzles)]×100) at which clogging of the nozzles constituting the droplet discharge head occurs after continuous operation was calculated, and it was investigated whether clogging can be eliminated using a cleaning member composed of a plastic material. The results were evaluated in terms of the four categories described below.

A: Nozzle clogging does not occur.

B: The occurrence rate of nozzle clogging is less than 0.5% (not including 0), and clogging can be eliminated by cleaning.

C: The occurrence rate of nozzle clogging is 0.5% or higher and less than 1.0%, and clogging can be eliminated by cleaning.

D: The occurrence rate of nozzle clogging is 1.0% or higher, and clogging cannot be eliminated by cleaning.

The evaluation described above was carried out in the same conditions for the examples and the comparative examples.

### 4. Manufacture of Color Filters

Color filters were manufactured using color filter inks obtained in each of the working examples and comparative examples, both immediately after the color filter inks were manufactured and after the color filter inks had been held at 60° C. for seven days (held in a heated environment). The manner in which the color filters were manufactured will now be explained.

First, a substrate (G5 size: 100 mm×1300 mm) composed of soda glass and having a silica (SiO₂) film for preventing elution of sodium ions formed on both sides thereof was prepared and washed.

Next, a radiation-sensitive composition for forming a partition wall containing carbon black was applied to the entire surface of one of the surfaces of the washed substrate to form a coated film.

Next, a pre-baking treatment was performed at a heating temperature of 110° C. and a heating time of 120 seconds.

After the pre-baking treatment, partition walls were formed by irradiating the radiation sensitive composition via a photomask, subjecting the same to post exposure baking (PEB), conducting a development treatment using an alkali development fluid, and then conducting a post baking treatment. PEB was carried out at a heating temperature of 110° C., a heating time of 120 seconds, and an irradiation intensity of 150 mJ/cm². The development processing was conducted using a vibration soaking method. The development treatment time was 60 seconds. The post baking treatment was carried out at a heating temperature of 150° C. for heating time of 5 minutes. The thickness of the partition wall thus formed was 2.1 μm.

Next, the color filter ink was discharged into the cells as areas surrounded by the partition walls by using a droplet discharge device such as that shown in FIGS. 3 to 6. Three colors of color filter ink were used and the color filter ink was discharged such that mixing of the colors did not occur. A droplet discharge head was used in which the nozzle plate had been joined using an epoxy adhesive (AE-40, manufactured by Ajinomoto Fine-Techno).

After depositing the color filter inks, a heat treatment was carried out for 10 minutes at 100° C. on a hot plate and another heat treatment was then carried out for one hour in an oven at 200° C. In this way, colored portions having three different n colors were formed. A color filter such as that shown in FIG. 1 was thereby obtained.

Using the method described above, 4000 color filters were manufactured with the color filter inks (ink set) obtained in each of the working examples and the comparative examples, i.e., each ink set was used to manufacture 4000 color filters per ink set.

### 5. Evaluation of Color Filters

The color filters obtained in the manner described above were evaluated in the manner described below

### 5-1. Unevenness of Color and Saturation

Of the 4000 color filters manufactured using the color filter inks (ink set) of each of the working examples and the comparative examples, the 4000^{th} color filter made with each ink set was used to manufacture a liquid crystal display device such as that shown in FIG. 7. All of the liquid crystal display devices were manufactured under the same conditions.

Red monochromatic display, green monochromatic display, blue monochromatic display, and white monochromatic display were visually observed in a dark room using these liquid crystal display devices and the occurrence of uneven color and uneven saturation between different regions was evaluated based on the five levels described below.

A: Uneven color and uneven saturation were not observed.

B: Uneven color and uneven saturation were substantially not observed.

C: Some uneven color and uneven saturation was observed.

D: Uneven color and uneven saturation were plainly observed.

E: Marked uneven color and uneven saturation were observed.

### 5-2. Differences in Characteristics Between Units

Of the color filters manufactured using the color filter inks (ink sets) of the examples and the comparative examples, the 1^{st} to the 10^{th} and the 3990^{th} to the 3999^{th} color filters manufactured of each working example and comparative example were prepared, red monochromatic display, green monochromatic display, blue monochromatic display, and white monochromatic display were carried out in a dark room, and the colors were measured using a spectrophotometer (MCPD 3990, manufactured by Otsuka Electronics). The maximum color differences (color difference ΔE in the Lab display system) in the 1^{st} to the 10^{th} and the 3990^{th} to the 3999^{th} color filters manufactured for each of the examples and comparative examples were calculated from the results and evaluated based on the five ranges described below.

A: Color difference (ΔE) is less than 2.

B: Color difference (ΔE) is equal to or larger than 2 and less than 3.

C: Color difference (ΔE) is equal to or larger than 3 and less than 4.

D: Color difference (ΔE) is equal to or larger than 4 and less than 5.

E: Color difference (ΔE) is 5 or more.

### 5-3. Durability

Of the color filters manufactured using the color filter inks (ink set) of each of the working examples and the comparative examples, the 101^{st} to 110^{th} color filters made with each ink set were used to manufacture a liquid crystal display device such as that shown in FIG. 7. All of the liquid crystal display devices were manufactured under the same conditions.

Red monochromatic display, green monochromatic display, and blue monochromatic display were visually observed in a dark room using these liquid crystal display devices and the occurrence of the light leakage (white spots, luminescent spots) was checked.

Next, the color filters were removed from the liquid crystal display devices.

Each of the removed color filters was placed successively in environments at the following temperatures: 20° C. for 1.5 hours, 50° C. for 2 hours, 20° C. for 1.5 hours, and −10° C. for 3 hours. Finally, the temperature was returned to 20° C., thereby completing one cycle (8 hours). This cycle was repeated 20 times (for a total treatment time of 160 hours).

Thereafter, the liquid crystal display devices like that shown in FIG. 7 were reassembled using these color filters.

Red monochromatic display, green monochromatic display, and blue monochromatic display were visually observed in a darkroom using these liquid crystal display devices and the occurrence of light leakage (white spots, luminescent spots) was evaluated based on the following five levels.

A: There were no color filters in which light leakage (white spots, luminescent spots) occurred.

B: Light leakage (white spots, luminescent spots) was observed in one or two color filters.

C: Light leakage (white spots, luminescent spots) was observed in three to five color filters.

D: Light leakage (white spots, luminescent spots) was observed in six to nine color filters.

E. Light leakage (white spots, luminescent spots) was observed in ten color filters.

### 6. Evaluation of Contrast

The color filter inks obtained in each of the working examples and comparative examples (color filter ink immediately after manufacturing) and color filter inks that had been held at 60° C. for seven days after manufacturing (color filter ink held in a heated environment) were evaluated by being subjected to the tests explained below.

The red ink of the ink set obtained in each of the working examples and comparative examples was used to form a red colored film on a different glass plate (diameter: 10 cm) using an inkjet method.

The colored films were formed by discharging droplets of the ink onto the glass plates, heating the glass plates on a hot plate for 10 minutes at 100° C., and heating the glass plates inside an oven for 1 hour at 200° C. The discharge quantity of the color filter ink was adjusted such that the colored films formed had a thickness of 1.5 μm.

The contrast (CR) was determined for each of the glass substrates on which a colored film was formed using a contrast tester (CT-1, manufactured by Tsubosaka Electric) and evaluated in terms of the three ranges described below.

A: CR was 3200 or higher.

B: CR was 2000 or higher and less than 3200.

C: CR was less than 2000.

The green and blue inks of the ink sets obtained in the working examples and comparative examples were used to form colored films on glass plates (diameter: 10 cm) using an inkjet method in the same manner as above, and the contrast was determined for each of the glass plates on which the colored films were formed.

The glass plates on which the green colored films had been formed were evaluated based on the three ranges described below.

A: CR was 11,000 or higher.

B: CR was 5500 or higher and less than 11,000.

C: CR was less than 5500.

The glass plates on which the blue colored films had been formed were evaluated based on the three ranges described below.

A: CR was 2900 or higher.

B: CR was 2600 or higher and less than 2900.

C: CR was less than 260.

In the evaluations described above, all of the color filters and glass plates were observed and measured under the same conditions.

The results are shown in Tables 5 and 6. In the table, results for color filter inks evaluated immediately after being manufactured are indicated as “Before heating” and results for color filter inks evaluated after being held at 60° C. for seven days (held in a heated environment) are indicated as “After heating.”

TABLE 5

| | | | | EVALUATION OF DROPLET | | | |
|---|---|---|---|---|---|---|---|
| | | | | DISCHARGE CHARACTERISTICS | | | |
| | | | | LANDING | | STABILITY OF | |
| | | APPEARANCE | | POSITION | | DROPLET | |
| | | CHANGE | | ACCURACY | | DISCHARGE QUANTITY | |
| | | AFTER | CHANGE IN | BEFORE | AFTER | BEFORE | AFTER |
| | | HEATING | VISCOSITY | HEATING | HEATING | HEATING | HEATING |
| EXAMPLE 1 | R INK | A | A | A | A | A | A |
| | G INK | A | A | A | A | A | A |
| | B INK | A | A | A | A | A | A |
| EXAMPLE 2 | R INK | A | A | A | A | A | A |
| | G INK | A | A | A | A | A | A |
| | B INK | A | A | A | A | A | A |
| EXAMPLE 3 | R INK | A | B | A | B | A | B |
| | G INK | B | B | B | B | A | B |
| | B INK | A | B | A | B | A | B |
| EXAMPLE 4 | R INK | B | B | A | B | A | B |
| | G INK | A | B | A | B | A | B |
| | B INK | A | B | A | B | A | B |
| EXAMPLE 5 | R INK | B | B | B | B | A | B |
| | G INK | A | B | A | B | A | B |
| | B INK | A | B | A | B | A | B |

| | | EVALUATION OF DROPLET | | | | | |
|---|---|---|---|---|---|---|---|
| | | DISCHARGE CHARACTERISTICS | | | | | |
| | | INTERMITTENT | | CONTINUOUS | | COLOR AND | |
| | | PRINTING | | DISCHARGE | | SATURATION | |
| | | PERFORMANCE | | TEST | | VARIATION | |
| | | BEFORE | AFTER | BEFORE | AFTER | BEFORE | AFTER |
| | | HEATING | HEATING | HEATING | HEATING | HEATING | HEATING |
| EXAMPLE 1 | R INK | A | A | A | A | A | A |
| | G INK | A | A | A | A | | |
| | B INK | A | A | A | A | | |
| EXAMPLE 2 | R INK | A | A | A | A | A | A |
| | G INK | A | A | A | A | | |
| | B INK | A | A | A | A | | |
| EXAMPLE 3 | R INK | A | B | A | B | A | A |
| | G INK | A | B | A | B | | |
| | B INK | A | B | A | B | | |
| EXAMPLE 4 | R INK | A | B | A | B | A | A |
| | G INK | A | B | A | B | | |
| | B INK | A | B | A | B | | |
| EXAMPLE 5 | R INK | A | B | A | B | A | A |
| | G INK | A | B | A | B | | |
| | B INK | A | B | A | B | | |

| | | DIFFERENCES IN | | | | | |
|---|---|---|---|---|---|---|---|
| | | CHARACTERISTICS | | | | | |
| | | BETWEEN UNITS | | DURABILITY | | CONTRAST | |
| | | BEFORE | AFTER | BEFORE | AFTER | BEFORE | AFTER |
| | | HEATING | HEATING | HEATING | HEATING | HEATING | HEATING |
| EXAMPLE 1 | R INK | A | A | A | A | A | A |
| | G INK | | | | | A | A |
| | B INK | | | | | A | A |
| EXAMPLE 2 | R INK | A | A | A | A | A | A |
| | G INK | | | | | A | A |
| | B INK | | | | | A | A |
| EXAMPLE 3 | R INK | A | B | A | A | A | B |
| | G INK | | | | | A | B |
| | B INK | | | | | A | A |
| EXAMPLE 4 | R INK | B | C | A | A | A | B |
| | G INK | | | | | A | A |
| | B INK | | | | | A | A |
| EXAMPLE 5 | R INK | A | B | A | A | A | B |
| | G INK | | | | | A | A |
| | B INK | | | | | A | A |

TABLE 6

| | | | | ELUATION OF DROPLET | | | |
|---|---|---|---|---|---|---|---|
| | | | | DISCHARGE CHARACTERISTICS | | | |
| | | APPEARANCE | | LANDING POSITION | | STABILITY OF DROPLET | |
| | | CHANGE | | ACCURACY | | DISCHARGE QUANTITY | |
| | | AFTER | CHANGE IN | BEFORE | AFTER | BEFORE | AFTER |
| | | HEATING | VISCOSITY | HEATING | HEATING | HEATING | HEATING |
| EXAMPLE 6 | R INK | B | B | A | B | A | B |
| | G INK | B | B | A | B | A | B |
| | B INK | A | B | A | B | A | B |
| COMPARATIVE | R INK | D | E | D | D | D | D |
| EXAMPLE 1 | G INK | D | E | D | D | D | D |
| | B INK | D | C | D | D | D | D |
| COMPARATIVE | R INK | D | E | D | D | D | D |
| EXAMPLE 2 | G INK | D | D | D | D | D | D |
| | B INK | D | E | D | D | D | D |
| COMPARATIVE | R INK | D | E | D | D | D | D |
| EXAMFLE 3 | G INK | D | D | D | D | D | D |
| | B INK | D | D | D | D | D | D |
| COMPARATIVE | R INK | D | E | D | D | D | D |
| EXAMPLE 4 | G INK | D | E | D | D | D | D |
| | B INK | D | D | D | D | D | D |

| | | EVALUATION OF DROPLET | | | | | |
|---|---|---|---|---|---|---|---|
| | | DISCHARGE CHARACTERISTICS | | | | | |
| | | INTERMITTENT PRINTING | | CONTINUOUS | | COLOR AND | |
| | | PERFORMANCE | | DISCHARGE TEST | | SATURATION VARIATION | |
| | | BEFORE | AFTER | BEFORE | AFTER | BEFORE | AFTER |
| | | HEATING | HEATING | HEATING | HEATING | HEATING | HEATING |
| EXAMPLE 6 | R INK | A | B | A | B | A | A |
| | G INK | A | B | A | B | | |
| | B INK | A | B | A | B | | |
| COMPARATIVE | R INK | C | C | D | D | E | E |
| EXAMPLE 1 | G INK | C | C | D | D | | |
| | B INK | B | B | D | D | | |
| COMPARATIVE | R INK | B | B | D | D | D | E |
| EXAMPLE 2 | G INK | B | B | D | D | | |
| | B INK | B | B | D | D | | |
| COMPARATIVE | R INK | B | B | D | D | E | E |
| EXAMFLE 3 | G INK | B | C | D | D | | |
| | B INK | B | B | D | D | | |
| COMPARATIVE | R INK | B | B | D | D | E | E |
| EXAMPLE 4 | G INK | B | B | D | D | | |
| | B INK | B | B | D | D | | |

| | | DIFFERENCES IN | | | | | |
|---|---|---|---|---|---|---|---|
| | | CHARACTERISTICS | | | | | |
| | | BETWEEN UNITS | | DURABILITY | | CONTRAST | |
| | | BEFORE | AFTER | BEFORE | AFTER | BEFORE | AFTER |
| | | HEATING | HEATING | HEATING | HEATING | HEATING | HEATING |
| EXAMPLE 6 | R INK | A | B | A | A | A | B |
| | G INK | | | | | A | B |
| | B INK | | | | | A | B |
| COMPARATIVE | R INK | E | E | E | E | C | C |
| EXAMPLE 1 | G INK | | | | | C | C |
| | B INK | | | | | C | C |
| COMPARATIVE | R INK | E | E | E | E | C | C |
| EXAMPLE 2 | G INK | | | | | C | C |
| | B INK | | | | | C | C |
| COMPARATIVE | R INK | E | E | E | E | C | C |
| EXAMFLE 3 | G INK | | | | | C | C |
| | B INK | | | | | C | C |
| COMPARATIVE | R INK | E | E | E | E | C | C |
| EXAMPLE 4 | G INK | | | | | C | C |
| | B INK | | | | | C | C |

As is clear from Tables 5 and 6, a color filter ink in accordance with the present invention has excellent droplet discharge stability, and unevenness of color and saturation and light leakage are suppressed in the color filters manufactured with a color filter ink in accordance with the present invention. Moreover, the variation of properties and characteristics among color filters manufactured in accordance with the present invention was small. The durability of color filters in accordance with the present invention was also excellent. In the present invention, the contrast was excellent. The stability of color filter inks in accordance with the present invention is excellent and the color filter inks can be discharged in a favorable fashion even after being held in a heated condition for some time. It was demonstrated that high quality color filters can be manufactured in a stable fashion using a color filter ink in accordance with the present invention. Conversely, satisfactory results were not obtained in the comparative examples.

Commercially available liquid crystal televisions were disassembled and the liquid crystal display device portions were exchanged with those manufactured in the manner described above. The similar evaluation as that described above was carried out and the similar results as those described above were obtained.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies. While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A method for manufacturing a color filter ink adapted to be used to manufacture a color filter by an inkjet method, the method comprising:
dispersing a dispersing agent in a solvent to obtain a dispersing-agent-dispersed liquid by agitating a mixture of the dispersing agent, a thermoplastic resin and the solvent;
performing a fine dispersion treatment to obtain a pigment dispersed material by adding a pigment to the dispersing-agent-dispersed liquid and by adding inorganic beads to the dispersing-agent-dispersed liquid in multiple stages; and
mixing the pigment dispersed material with a curable resin.

2. The method recited in claim 1, wherein
the mixing of the pigment dispersed material with the curable resin includes mixing the pigment dispersed material with an epoxy resin having a silyl acetate structure (SiOCOCH3) and an epoxy structure as the curable resin.

3. The method recited in claim 1, wherein
the performing of the fine dispersion treatment includes executing a first dispersion using first inorganic beads having a prescribed average particle diameter and then executing a second dispersion using second inorganic beads having a smaller average particle diameter than the first inorganic beads.

4. The method recited in claim 3, wherein
the first inorganic beads have an average particle diameter of 0.5 to 2.0 mm and the second inorganic beads have an average particle diameter of 0.03 to 0.30 mm.

5. The method recited in claim 3, wherein
the performing of the fine dispersion treatment includes performing only two dispersion stages including the first dispersion and the second dispersion.

6. The method recited in claim 1, wherein
the solvent includes one or more compounds selected from the group consisting of 1,3-butylene glycol diacetate, diethylene glycol dibutyl ether, and diethylene glycol monobutyl ether acetate.

7. The method recited in claim 1, wherein
the pigment includes one of C.I. pigment red 177, C.I. pigment red 177 and a derivative thereof, C.I. pigment red 254, and C.I. pigment red 254 and a derivative thereof.

8. The method recited in claim 1, wherein
the pigment includes one of C.I. pigment green 58, and C.I. pigment green 58 and a derivative of a pigment other than C.I. pigment green 58.

9. The method recited in claim 1, wherein
the pigment includes one of C.I. pigment blue 15:6, and C.I. pigment blue 15:6 and a derivative of C.I. pigment blue 15.

10. A color filter ink manufactured using the method recited in claim 1.

11. The color filter ink recited in claim 10, wherein
a content of the pigment in the color filter ink is 4.0 to 9.4 wt %,
a viscosity of the color filter ink at 25° C. is 11 mPa-s or smaller, and
an amount of change in the viscosity of the color filter ink at 25° C. after the color filter ink has been held at 60° C. for seven days is 0.5 mPa-s or less.

12. A color filter manufactured using the color filter ink recited in claim 10.

13. An image display device including the color filter recited in claim 12.

14. The image display device recited in claim 13, wherein
the image display device is a liquid crystal panel.

15. An electronic device including the image display device recited in claim 13.
